(19) United States
(12) Patent Application Publication
(10) Pub. No.: US 2026/0196925 A1
(43) Pub. Date: Jul. 9, 2026

(54) Multi-Stage Fast Dynamic Response Power Architecture and Controller

(71) Applicant: Queen's University at Kingston, Kingston (CA)

(72) Inventors: Yan-Fei Liu, Kingston (CA); Samuel Dylan Webb, Unionville (CA)

(21) Appl. No.: 19/441,096

(22) Filed: Jan. 6, 2026

Related U.S. Application Data
(60) Provisional application No. 63/742,602, filed on Jan. 7, 2025.
(60) Provisional application No. 63/751,819, filed on Jan. 30, 2025.
(60) Provisional application No. 63/761,153, filed on Feb. 20, 2025.

(51) Int. Cl. H02M 1/32; H02M 1/14; H02M 3/158

(52) U.S. Cl. CPC H02M 1/32; H02M 1/143; H02M 3/1586

(57) ABSTRACT

DC-DC converters, controllers, and control methods include an output stage having a plurality of DC-DC converter circuits connected together in parallel, wherein each DC-DC converter circuit contributes a small amount such as 5% or less of the total output current. Control of the plurality of DC-DC converter circuits may be based on voltage mode control or current mode control, and may include an accelerating mode control in response to a loading transient, or a braking mode control in response to an unloading transient, or a combination of accelerating mode and braking mode control. Embodiments are suitable for low voltage, high current applications such as data center power supplies, and may be readily adapted and scalable to various applications requiring various voltage conversions and output current requirements.

### RELATED APPLICATIONS

This application claims the benefit of Application No. 63/742,602 filed on Jan. 7, 2025, Application No. 63/751,819 filed on Jan. 30, 2025, and Application No. 63/761,153 filed on Feb. 20, 2025, the contents of which are incorporated herein by reference in their entirety.

### FIELD

The invention relates generally to the field of DC-DC converters. More specifically, the invention provides multi-stage fast dynamic response power architectures and related control techniques for DC-DC converters with high current loads capable of fast response to loading and unloading output current transients. Embodiments are particularly suitable for low voltage, high current applications such as data center processors.

### BACKGROUND

Increasingly large data centers and artificial intelligence installations require improved power density and efficiency of power architectures. In typical approaches the input voltage of the motherboard has been increased from commonly used 12V to around 48V. This requires the motherboard power converter to convert the 48V to low voltage, such as 0.7V, that powers the processors, such as CPU (Central Processing Unit), GPU (Graphic Processing Unit), FPGA (Field Programmable Gate Array), etc.

The supply voltage (Vcc) for CPU, GPU, FPGA, etc. (herein after referred to simply as “GPU”), is around 0.6V to 1.2V. Typically the voltage is about 0.7V and the current may be from 1,000 A to 2,000 A. As the technology evolves the voltage will further decrease, and the current will further increase, making the design of high power density and efficiency even more challenging.

FIG. 1 is a block diagram of the power delivery architecture used in a typical 48V to 0.7V power conversion. The 48V is converted to a bus voltage, Vbus, around 12V. Then a plurality of Buck converters are connected in parallel to produce the required GPU voltage of Vo=0.7V. In the example of FIGS. 1, 20 Buck converters are connected in parallel to produce 1,000 A load current. Therefore, each Buck converter produces 50 A.

For the purpose of discussion, it is assumed that the bus voltage Vbus=12V and the output current of the LLC DC to DC converter is 58 A. The output power of the LLC DC to DC is 700 W, the input power Pin is 700 W and the input current Iin=14 A, as shown in FIG. 1.

FIG. 2 shows the circuit diagram of one Buck converter topology according to the prior art, e.g., Buck 1 in FIG. 1. The Buck converter will produce output current Io1=50 A. It is assumed that the switching frequency of each Buck converter is Fs_buck=750 kHz and the inductor value is LB1=40 nH, resulting in an inductor current ripple of around 22 A peak-to-peak which is considered as a reasonable selection of the inductor value.

During operation the GPU current will change dramatically from light load to heavy load, and from heavy load to light load. In this example, when GPU takes full load current, Io=1,000 A, each Buck converter produces 50 A. When GPU current steps from 1,000 A to 0 A, the controller will turn off the control FET Q11, and turn on the synchronous rectifier FET (SR FET) Q12, shown in FIG. 2, so that no power is delivered from the input source, as shown in FIG. 3. The GPU current step from heavy load to light load is referred to as an unloading transient. In this example the worst case unloading transient is when the GPU current steps from 1,000 A to 0 A.

For the 20 Buck converters of FIG. 1 the equivalent Buck inductor is LBeq=LB1/20=40 nH/20=2 nH, since all 20 Buck inductors are connected in parallel. The energy stored in the Buck inductors will be transferred to the capacitor connected across the GPU, Cgpu, and the voltage across Cgpu, which is same as the output voltage, Vo, will rise. The overshoot voltage is defined as Vo_overshoot.

Assuming that the allowed overshoot voltage V_overshoot is 100 mV, the energy stored in the Buck inductors, E_ind, is calculated as:

$$E\_ind = 0.5 * LBeq * Io * Io = 0.5 * 2 nH * 1 , 000 * 1 , 000 = 1 , 000 uJ ( Micro Joule ) . \qquad ( 1 )$$

When this energy is transferred to Cgpu the voltage will rise to

$$Vmax = Vo + Vo\_overshoot = 0.7 + 0.1 V = 0.8 V . \qquad ( 2 )$$

The required Cgpu value to limit Vmax below 0.8V is calculated approximately as follows:

$$Cgpu = E\_ind / ( Vo * Vo\_overshoot ) = 1 , 000 / ( 0.7 * 0.1 ) = 14 , 286 uF ( micro - Farad ) . \qquad ( 3 )$$

Thus, a large capacitor value of Cgpu=14,500 uF is needed to keep the overshoot below 100 mV during unloading conditions when the GPU current steps from 1,000 A to 0 A. It is noted that in applications where lower GPU voltage is required, the required capacitor value is larger. For example, if Vo is reduced to 0.5V and V_overshoot is reduced to 70 mV, the required Cgpu=30,000 uF, which is 2× the capacitor size required for 0.7V GPU voltage.

However, it is not desirable that such a large capacitor value is needed to limit the overshoot of the output voltage, as large capacitors are bulky and are prone to failure. This is a significant drawback of prior approaches that can reduce their reliability and longevity.

### SUMMARY

Described herein are circuits for multi-stage fast dynamic response power architectures and related control techniques for high current loads with rapid transient, such as processor applications. Using a zero inductor voltage (ZIV) current multiplier module as the output stage connected to the load, the dynamic response of the power supply is significantly improved, and the output capacitor is significantly reduced, compared to prior approaches. Overall efficiency of the power system is also increased.

According to one aspect of the invention there is provided a DC-DC converter, comprising: a voltage regulator stage adapted to receive a first bus voltage and output a regulated second bus voltage that is lower than the first bus voltage; an output stage adapted to receive the regulated second bus voltage and provide an output voltage that is regulated at a lower voltage according to the regulated second bus voltage; wherein the output stage comprises at least one zero inductor voltage (ZIV) DC transformer (DCX); and a controller; wherein the controller controls operation of the voltage regulator stage to regulate the second bus voltage; wherein the controller uses a sensed output voltage to control operation of the output stage by alternating between an accelerating mode and a braking mode in response to a DC-DC loading or unloading transient, respectively; wherein the alternating between the accelerating mode and the braking mode continues until the output voltage recovers to a selected value.

One embodiment comprises an input stage adapted to receive an input voltage and output the first bus voltage.

In one embodiment the input stage comprises at least one ZIV converter.

In one embodiment the voltage regulator stage comprises at least one Buck converter.

In one embodiment the output stage comprises a plurality of ZIV converters connected together in parallel.

In one embodiment the output stage comprises a plurality of micro-Buck converters connected together in parallel.

In one embodiment four micro-Buck converters are connected in parallel as a micro-Buck module.

In one embodiment the controller implements interleaved operation of the four micro-Buck converters of the micro-Buck module.

In one embodiment each of the four micro-Buck converters of the micro-Buck module operates according to an interleaved 25% duty cycle.

According to another aspect of the invention there is provided DC-DC converter, comprising: a plurality of DC-DC converter circuits connected together in parallel and adapted to receive a DC input voltage and output a DC output voltage; and a controller that implements current mode control of the plurality of DC-DC converter circuits; wherein the controller senses the DC output voltage and generates a current reference signal based on the sensed DC output voltage; wherein the current reference signal is transmitted to the plurality of DC-DC converter circuits; wherein an output current of each of the plurality of DC-DC converter circuits is based on the current reference signal; wherein the plurality of DC-DC converter circuits together produce a total load current.

In one embodiment the controller comprises a voltage error amplifier that is used to generate the current reference signal.

In one embodiment the controller implements current control accelerating mode in response to a loading transient.

In one embodiment the controller implements current control braking mode in response to an unloading transient.

In one embodiment the controller terminates current control accelerating mode when the output voltage recovers to a selected value.

In one embodiment the controller terminates current control braking mode when the output voltage recovers to a selected value.

In one embodiment the controller terminates current control accelerating mode after a pre-determined time interval.

In one embodiment the controller terminates current control braking mode after a pre-determined time interval.

In one embodiment the DC-DC converter comprises a plurality of DC-DC converter circuits connected together in parallel as a DC-DC converter module; wherein the controller implements interleaved operation of the plurality of DC-DC converter circuits to substantially reduce or eliminate at least one of input current and output current ripple.

In one embodiment the DC input voltage is selected to be a value that substantially reduces or eliminates input current ripple by interleaving operation of the plurality of DC-DC converter circuits.

In one embodiment each of the plurality of DC-DC converter circuits produces 0.1% to 5% of the total load current.

In one embodiment each of the plurality of DC-DC converter circuits comprises a Buck converter including a synchronous rectifier (SR) switch, a control switch, and an inductor; wherein the controller controls operation of each Buck converter during current control braking mode operation wherein the SR switch is turned on when the control switch is turned off; wherein inductor energy is transferred to an inductor input side to reduce an output voltage overshoot.

In one embodiment the controller implements predictive peak current mode control for each DC-DC converter circuit.

In one embodiment the controller implements a digital signal transfer protocol to transfer the current reference signal of the controller to a current reference input of each of the DC-DC converter circuits.

In one embodiment the plurality of DC-DC converter circuits comprises four Buck converter circuits connected together in parallel as a module; wherein the controller operates the four Buck converter circuits according to an interleaved duty cycle of about 25%.

According to another aspect of the invention there is provided a controller for a DC-DC converter comprising a plurality of DC-DC converter circuits connected together in parallel and adapted to receive a DC input voltage and output a DC output voltage, wherein the controller controls operation of the plurality of DC-DC converter circuits to regulate the output voltage, comprising: using a sensed output voltage to generate a current reference signal and to generate at least one of a current control accelerating mode signal and a current control braking mode control signal; wherein applying the current control accelerating mode signal controls operation of the plurality of DC-DC converter circuits in response to a loading transient; wherein the controller terminates the current control accelerating mode signal when the output voltage recovers to a selected value; wherein applying the current control braking mode signal controls operation of the plurality of DC-DC converter circuits in response an unloading transient; wherein the controller terminates the current control braking mode signal when the output voltage recovers to a selected value.

According to another aspect of the invention there is provided a method for implementing a DC-DC converter, comprising: providing a voltage regulator stage adapted to receive a first bus voltage and output a regulated second bus voltage that is lower than the first bus voltage; providing an output stage adapted to receive the regulated second bus voltage and provide an output voltage that is regulated at a lower voltage according to the regulated second bus voltage; wherein the output stage comprises at least one zero inductor voltage (ZIV) DC transformer (DCX); and controlling operation of the voltage regulator stage to regulate the second bus voltage; sensing an output voltage of the DC-DC converter to control operation of the output stage by alternating between an accelerating mode and a braking mode in response to a DC-DC loading or unloading transient, respectively; wherein the alternating between the accelerating mode and the braking mode continues until the output voltage recovers to a selected value.

According to another aspect of the invention there is provided a method for implementing a DC-DC converter, comprising: providing a plurality of DC-DC converter circuits connected together in parallel and adapted to receive a DC input voltage and output a DC output voltage; and using a controller that implements current mode control of the plurality of DC-DC converter circuits; wherein the controller senses the DC output voltage and generates a current reference signal based on the sensed DC output voltage; wherein the current reference signal is transmitted to the plurality of DC-DC converter circuits; wherein an output current of each of the plurality of DC-DC converter circuits is based on the current reference signal; wherein the plurality of DC-DC converter circuits together produce a total load current.

According to another aspect of the invention there is provided a method for controlling for a DC-DC converter comprising a plurality of DC-DC converter circuits connected together in parallel and adapted to receive a DC input voltage and output a DC output voltage, wherein the controller controls operation of the plurality of DC-DC converter circuits to regulate the output voltage, comprising: using a sensed output voltage to generate a current reference signal and to generate at least one of a current control accelerating mode signal and a current control braking mode control signal; wherein applying the current control accelerating mode signal controls operation of the plurality of DC-DC converter circuits in response to a loading transient; wherein the controller terminates the current control accelerating mode signal when the output voltage recovers to a selected value; wherein applying the current control braking mode signal controls operation of the plurality of DC-DC converter circuits in response an unloading transient; wherein the controller terminates the current control braking mode signal when the output voltage recovers to a selected value.

### BRIEF DESCRIPTION OF THE DRAWINGS

For a greater understanding of the invention, and to show more clearly how it may be carried into effect, embodiments will be described, by way of example, with reference to the accompanying drawings, wherein:

FIG. 1 is a block diagram of a conventional power delivery architecture according to the prior art.

FIG. 2 is a schematic diagram of a Buck converter topology according to the prior art.

FIG. 3 is an equivalent circuit diagram of a Buck converter during braking mode when the load current steps from full load to no load, according to the prior art.

FIG. 4 is a schematic diagram of a 24-switch zero inductor voltage (ZIV) topology (24S ZIV DCX), according to the prior art, for 50V to 12.5V conversion.

FIG. 5 is a timing diagram showing gate signals for the 24-switch ZIV topology of FIG. 4, according to the prior art.

FIG. 6 is a schematic diagram of a 24-switch ZIV topology according to the prior art, for 2.8V to 0.7V conversion.

FIG. 7 is a block diagram of a power architecture for 48V to 0.7V conversion, according to one embodiment.

FIG. 8 is a block diagram of a power architecture for 48V to 0.7V conversion with a controller, according to one embodiment.

FIG. 9 is a schematic diagram showing Braking Mode operation of ZIV DCX modules during an unloading transient to reduce the output voltage overshoot, according to one embodiment.

FIG. 10 is a schematic diagram showing Accelerating Mode operation of ZIV DCX modules during a loading transient to reduce the output voltage undershoot, according to one embodiment.

FIG. 11 is a diagram of waveforms of output voltage (Vo) and Vbus2 during an unloading transient with alternating Braking Mode and Accelerating Mode operation using ZIV DCX modules, according to one embodiment.

FIG. 12 is a diagram of waveforms of output voltage (Vo) and Vbus2 during a loading transient with alternating Braking Mode and Accelerating Mode operation using ZIV DCX modules, according to one embodiment.

FIG. 13 is a block diagram of control logic for alternating Accelerating Mode and Braking Mode operation, according to one embodiment.

FIG. 14 is a block diagram of a two-stage architecture wherein the output stage is implemented with Micro-Buck Modules, according to one embodiment.

FIG. 15 is a schematic diagram of a micro-Buck converter implemented with a Buck converter based on the prior art, with nomenclature used herein.

FIG. 16A is a schematic diagram of an implementation of a Micro-Buck Module (MBM) including four micro-Buck converters connected together in parallel, according to one embodiment.

FIG. 16B is a timing diagram showing interleaved gate drive signals for the embodiment of FIG. 16A, according to one embodiment.

FIG. 17 is a block diagram of a three-stage power system architecture for 50V to 0.7V conversion using Micro-Buck Modules in Stage 3, according to one embodiment.

FIG. 18 is a block diagram of self-controlled Micro-Buck Modules with voltage loop control, according to one embodiment.

FIG. 19 is a block diagram of self-controlled Micro-Buck Modules with current loop control, according to one embodiment.

FIG. 20A is a schematic diagram of an implementation of a Micro-Buck Module including four micro-Buck converters connected together in parallel and a current mode controller, according to one embodiment.

FIG. 20B is a timing diagram showing interleaved control current waveforms for the embodiment of FIG. 20A, according to one embodiment.

FIG. 21 is a diagram showing typical waveforms for Current Control Accelerating Mode operation, according to one embodiment.

FIG. 22A is a plot of simulation results for a loading response of a current mode controlled MBM (MBMC) where the output current steps from 5 A to 20 A; output voltage (top trace), output current, control current, inductor current, and total inductor current (bottom trace), according to one embodiment wherein the output capacitor C2=20 uF.

FIG. 22B is a plot of simulation results for a loading response of an MBMC where the output current steps from 5 A to 20 A; control FET current (top four traces), output current, and control current (bottom trace), according to one embodiment.

FIG. 22C is a plot of simulation results for an unloading response of an MBMC where the output current steps from 20 A to 5 A; output voltage (top trace), output current, control current, inductor current, and total inductor current (bottom trace), according to one embodiment the output capacitor C2=20 uF.

FIG. 22D is a plot of simulation results for an unloading response of an MBMC wherein the output current steps from 20 A to 5 A; control FET current (top four traces), output current, and control current (bottom trace), according to one embodiment.

FIG. 22E is a plot of simulation results of output voltage of an MBMC module response with a conventional PID controller, wherein C2=140 uF.

FIG. 23 is a diagram of a Q11A (see FIG. 20A) current waveform for Current Control Accelerating Mode operation with two current accelerating current levels, according to one embodiment.

FIG. 24 is a control block diagram for Current Control Accelerating Mode and Current Control Braking Mode operation, according to one embodiment.

FIG. 25 is a diagram of output voltage Vo and GPU current Igpu waveforms for Current Control Braking Mode operation, according to one embodiment.

FIG. 26 is a block diagram of a DC-DC converter with multiple MBMC modules each producing a different output voltage.

### DETAILED DESCRIPTION OF EMBODIMENTS

Described herein are circuits, methods, and controllers that overcome drawbacks of conventional high current power supplies typically used in applications such as data centers. Embodiments described herein feature improved power density, efficiency, transient response, and reliability of high current power solutions relative to currently known solutions. Transients occur when the load current changes rapidly from high or maximum current to low or minimum (or zero) current, referred to as an unloading transient, and when the load current changes rapidly from low or minimum (or zero) current to high or maximum current, referred to herein as a loading transient. Embodiments control the transient response to minimize output voltage overshoot during unloading transients and to minimize the output voltage undershoot during loading transients. Embodiments enable reduced size of output passive components (capacitors and inductors), thereby improving power density and reliability of power solutions.

In this specification, controlling operation during an unloading transient is referred to as Braking Mode operation or Braking Mode. Controlling operation during a loading transient is referred to as Accelerating Mode operation or Accelerating Mode.

To simplify the description and analysis presented herein, embodiments will be described based on the following parameters and assumptions:
(1) Input voltage Vin=50V.
(2) Output voltage Vo=0.7V.
(3) Output current Io=1,000 A.
(4) Total load power Po=0.7V×1,000 A=700 W.
(5) The efficiency of power conversion is assumed to be 100% (loss is neglected).
(6) The load is a GPU.
   However, it will be appreciated that embodiments may be readily adapted for operation at parameters other than the above, or ranges encompassing the above. For example, in some embodiments Vin may be 45V to 55V and/or Vo may be 0.6V to 1.2V. Vo may change or be selected based on, e.g., different loads, chips, etc. and/or operating conditions.

### Section 1: Unloading Transient Response of Prior Power Solution Based on Buck Converters

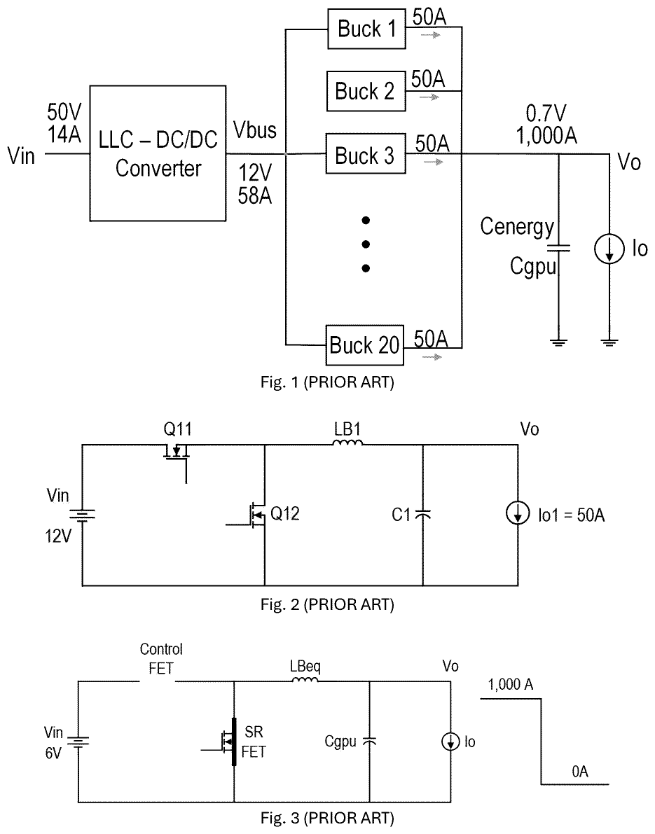

Referring to the prior approach of FIGS. 1-3, as discussed above, the full load GPU current Io=1,000 A, wherein each of the 20 Buck converter produces 50 A. When GPU current steps from 1,000 A to 0 A (zero Ampere), the controller will turn off the control FET, such as Q11, and turn on Synchronous Rectifier FET (SR FET), such as Q12, so that no power is delivered from input source, as shown in FIG. 3. A more commonly used method is to turn off Q11 only such that the inductor current flows through the body diode of Q12.

### Section 2: Zero Inductor Voltage (ZIV) Topology

Described herein is a multi-stage fast dynamic response power architecture and related control strategy that significantly reduces the size of the required output capacitor Cgpu to limit the output voltage overshoot and undershoot to their required values. Embodiments may employ a zero inductor voltage (ZIV) topology (e.g., [1], [2]). ZIV topology can achieve very high efficiency and high power density by using low switching frequency (therefore exhibiting low switching loss) and a small inductor value. In ZIV topology, the duty cycle is constant at 25%, or 50%, or some other value.

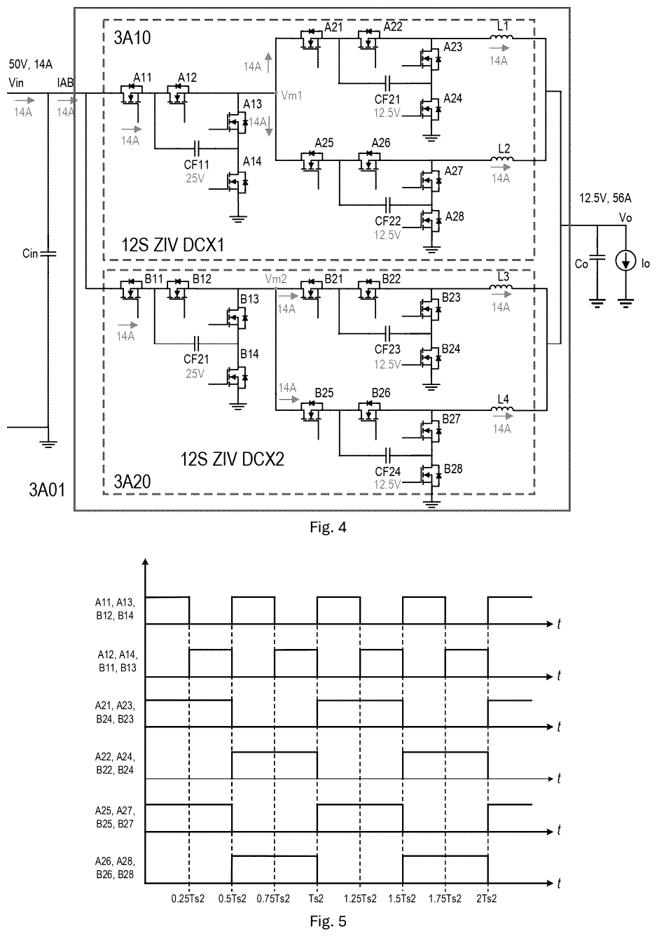

FIG. 4 is a circuit diagram of one embodiment based on a 24-switch ZIV topology (24S ZIV DCX), which includes two 12-switch ZIV topologies (12S ZIV DCX1 and 12S ZIV DCX2) connected in parallel, referred to as 3A10 and 3A20, respectively. Each of the 12-switch ZIV topologies includes three flying capacitors and two output inductors (e.g., CF11, CF21, CF22 and L1, L2 in 3A10). An input capacitor Cin is connected across the input voltage Vin and an output capacitor Co is connected across the output voltage Vo.

In the ZIV topology, the instantaneous inductor voltage depends on the ripple voltage of the flying capacitor. The instantaneous inductor voltage does not depend on the DC value of the input voltage and output voltage. It is assumed that the voltage ripples of the input capacitor Cin and output capacitor Co are very small and are neglected in the analysis.

The term DCX refers to a DC transformer and is used in the power electronics field to describe a circuit that can convert one DC voltage to another DC voltage with fixed voltage gain and very high efficiency and power density.

Gate drive signals for the switches (e.g., MOSFETs) according to one embodiment are shown in FIG. 5 wherein A11, A13, B12, B14 refer to the gate drive signals for MOSFETs A11, A13, B12, B14, and so on. In this embodiment the gate signals of the MOSFETs in 3A20 (12S ZIV DCX2) are out of phase with the gate signals of the MOSFETs in 3A10 (12S ZIV DCS1). For example, MOSFET A11 and MOSFET B11 are both at 50% duty cycle and are out of phase. The current at the right side of Cin, IAB, is a DC current because of interleaving operation. Therefore, the current through Cin is the ripple current and is very low or substantially zero. This significantly reduces the Cin value and the loss related to the equivalent series resistor (ESR) of Cin, which are favourable advantages for implementation over prior approaches. The 24-switch ZIV topology (24S ZIV DCX) embodiment of FIG. 4 achieves 50V to 12.5V (4:1) voltage step-down ratio(the output voltage is 25% of the input voltage) and the output current (56 A) is 4 times the input current (14 A). Thus the relationship between input voltage (Vin), current (Iin), and output voltage (Vo), output current (Io) for 24S ZIV DCX are as follows:

$$Vo = 0.25 * Vin \qquad ( 4.1 )$$

$$Io = 4 * Iin \qquad ( 4.2 )$$

In equation (4.2), Iin is the DC input current.

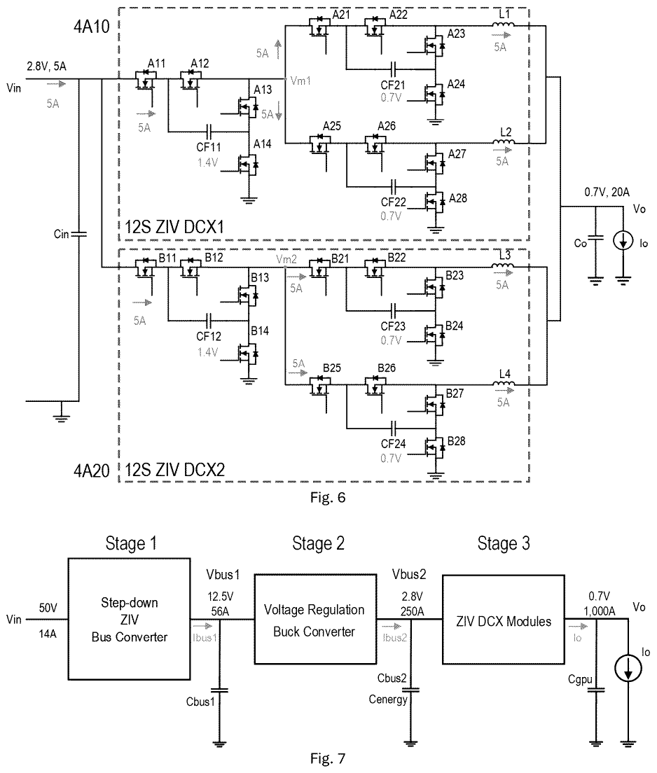

In some embodiments the same 24S ZIV DCX topology may also be used to achieve 2.8V to 0.7V voltage step down conversion, as shown in the embodiment of FIG. 6, where the gate drive signals shown in FIG. 5 may be used. Vo of 0.7V may be applied to a load such as a GPU. In FIG. 6, it is assumed that the output current is 20 A. The current through each inductor is Io/4=5 A. The input current is also 5 A. The ripple current through capacitor Cin is very small and close to zero because of interleaving operation. The voltage stress for MOSFETs in the second stage (A21, A22, . . . , A28 and B21, B22, . . . , B28) is same as the output voltage, Vo=0.7V. The voltage stress for MOSFETs in the first stage (A11, A12, A13, A14 and B11, B12, B13, B14) is half of the input voltage, which is 2.8V/2=1.4V. Therefore, these MOSFETs can be fabricated using low voltage integrated circuit process, such as 45 nm, 65 nm, 90 nm, or 180 nm process.

As used herein, the term ZIV DCX includes all DC to DC converter topologies wherein the instantaneous inductor voltage depends on the ripple voltage of the flying capacitor, input capacitor, and output capacitor. For example, a three-level Buck converter operating at 50% duty cycle is also a ZIV DCX as its inductor voltage is zero at 50% duty cycle. A 7-switch ZIV topology as described in [2] is another form of ZIV DCX.

### Section 3.1 Power Architecture

FIG. 7 is a block diagram showing a power architecture according to one embodiment. The embodiment is shown for 50V to 0.7V, 1,000 A application; however, as noted above, other voltages and currents may be configured. The power architecture has three stages. Stage 1 is a step-down stage, which may be a 24S ZIV DCX, e.g., as shown in FIG. 4. Stage 1 converts the input voltage Vin=50V to a first bus voltage Vbus1, which is about 12.5V (Vbus1=50V/4=12.5V) with very high efficiency, e.g., 98 to 99%. Other high efficiency, small size DC bus converters may also be used as the first stage.

Stage 2 is a voltage regulation stage, which may be implemented using, e.g., a multi-phase Buck converter. Stage 2 regulates the output voltage (Vo) to the desired value by regulating its output voltage (Vbus2) to a desired value. Stage 2 converts Vbus1 (around 12.5V) to Vbus2 (around Vbus2=2.8V) so that the output voltage Vo is regulated at 0.7V. A capacitor connected to Vbus2 is Cbus2 (also noted as Cenergy). As discussed below, Cbus2 (Cenergy) absorbs energy released from inductors of the voltage regulation stage during unloading transient.

Stage 3 is another step-down stage which may be implemented with a ZIV DCX module. For example, a 24S ZIV DCX, as shown in the embodiment of FIG. 6 may be used. Stage 3 converts Vbus2 into the output voltage Vo=0.7V with a fixed voltage step down ratio of 4. In one embodiment stage 3 may be implemented using a power application specific integrated circuit (PASIC) plus external capacitors and inductors to (1) improve efficiency, (2) reduce the size of the third stage, and (3) improve the transient response. The PASIC may contain all the MOSFETs, the gate drive circuit, and logic circuit. More details are discussed below.

For the purpose of this description, it is assumed that each ZIV DCX module produces 20 A load current at output voltage of 0.7V. Therefore, 50 ZIV DCX modules are needed to produce 1,000 A load current in Stage 3. In an actual implementation a design compromise may be needed to determine the optimal output current of each ZIV DCX module.

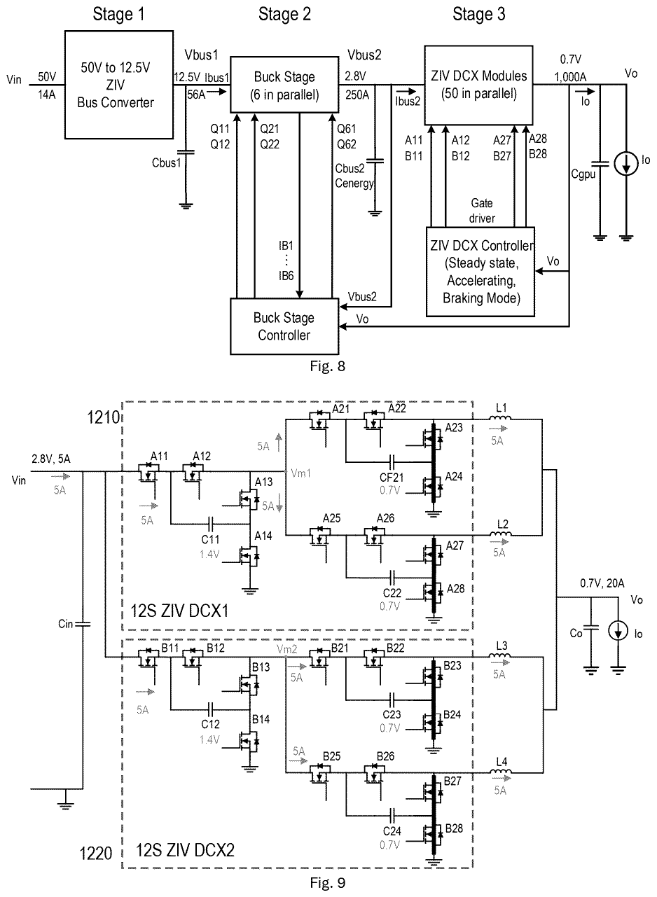

FIG. 8 is a high-level control block diagram according to one embodiment that may be used for the power architecture of the embodiment shown in FIG. 7.

Referring to FIG. 8, Stage 1 operates as a Bus converter. In this embodiment its output voltage Vbus1 is 25% of the input voltage. Vbus1=Vin/4=50V/4=12.5V.

Stage 2 uses Buck converters to convert the Vbus1=12.5V to Vbus2=2.8V. The Buck converters regulate the voltage Vbus2 so that the output voltage Vo is regulated at the required value, such as 0.7V in this example. As shown, Vbus2 is about 4 times the output voltage, 4*0.7=2.8V. However, in practical applications, due to loss in stage 3, Vbus2 will be higher than 2.8V, such as 3V.

Based on the output power, the number of Buck converters connected in parallel may be different. In this example the output power is

$$Po = Vo * Io = 0.7 V * 1 , 000 A = 700 W . \qquad ( 6 )$$

Therefore, the output current of all the Buck converters is:

$$Io\_buck = Ibus 2 = 700 W / 2.8 V = 250 A . \qquad ( 7 )$$

As an example, 6 Buck converters may be used in parallel to produce Io_buck=250 A. Each Buck converter produces Io_buck1=250 A/6=42 A. Considering the devices currently available, this is a reasonable selection.

The output voltage of the Buck converters in Stage 2, Vbus2, is controlled by the output voltage of the ZIV DCX by sensing Vo and Vbus2 using feedback loops, as shown in FIG. 8. The sensed Vo and Vbus2 are used by a Buck stage Controller to determine the drive signals for the switches of the Buck converters of Stage 2, to regulate Vbus2. The sensed Vo is also used by a ZIV DCX Controller to determine the drive signals for the switches of the ZIV DCX Modules of Stage 3 to implement steady state, Accelerating Mode, and Braking Mode operation.

When the GPU experiences a loading transient (GPU current changes suddenly from low level to high level, such as 0 A to 1,000 A), the ZIV DCX output voltage (Vo) and the Buck output voltage (Vbus2) will reduce from the steady state value, and it will take some time to recover. The undershoot values are Vo_undershoot and Vbus2_undershoot.

When the GPU experiences an unloading transient (GPU current changes suddenly from high level to low level, such as 1,000 A to 0 A), the ZIV DCX output voltage (Vo) and the Buck output voltage (Vbus2) will rise from steady state value, and it will take some time to recover. The overshoot values are Vo_overshoot and Vbus2_overshoot.

Stage 3 includes ZIV DCX modules. In this example with 20 A for each ZIV DCX output voltage, 50 ZIV DCX modules are needed, connected in parallel, to produce 1,000 A output current. Since the output inductor value of the ZIV DCX module is very small, such as, e.g., around 5 nH, each ZIV DCX module is primarily resistive, and current sharing among the 50 ZIV DCX modules may be achieved passively without the need for active current sharing control.

The value of the flying capacitors (e.g., CF11, CF21, CF22, CF12, CF23, CF24 in FIG. 6) is not critical. In one embodiment the flying capacitors may be selected at about 10 uF, the switching frequencies may be selected as Fs2=2 MHz (second stage MOSFETs) and Fs1=4 MHz (first stage MOSFETs), as summarized below:

$$CF 11 = CF 12 = CF 21 = CF 22 = CF 23 = CF 24 = 10 uF \qquad ( 8.1 )$$

$$L\_ziv = L 1 = L 2 = L 3 = L 4 = 5 nH \qquad ( 8.2 )$$

$$Fs 1 ( for A 11 , A 12 , A 13 , A 14 , B 11 , B 12 , B 13 , B 14 ) = 4 MHz \qquad ( 8.3 )$$

$$Fs 2 ( for A 21 , A 22 , A 23 , A 24 , A 25 , A 26 , A 27 , A 28 ) = 2 MHz \qquad ( 8.4 )$$

$$Fs 2 ( for B 21 , B 22 , B 23 , B 24 , B 25 , B 26 , B 27 , B 28 ) = 2 MHz \qquad ( 8.5 )$$

Under the above conditions, it is calculated that the peak to peak inductor current ripple through L1, L2, L3, L4, is 1 A. Considering the DC current through the inductor is 5 A, this ripple current is very small (about 10% inductor current ripple ratio). Thus, the selection of L_ziv=5 nH is a very conservative selection. In actual implementations an L_ziv value smaller than 5 nH may be used.

During steady-state operation, all ZIV DCX modules operate at 50% duty cycle and the output voltage Vo is about 25% of the input voltage Vbus2.

### Section 3.2: Control Strategy

Considering that the equivalent inductor value for ZIV DCX modules (stage 3) is much smaller than the equivalent inductor value of the Buck converters (stage 2), a feature of embodiments described herein is that during loading and unloading transients, the ZIV DCX modules will repeatedly operate between Braking Mode and Accelerating Mode until the output voltage recovers to steady state operation. In this way, the output voltage Vo may be tightly controlled to the desired value during very large load step changes.

During the loading transient, the output voltage of the Buck converters, Vbus2, will also change. Since Vo is controlled tightly by repeated Braking Mode and Accelerating Mode operation of ZIV DCX, the Vbus2 variation range is not critical, as long as the minimum Vbus2 is higher than Vo and maximum Vbus2 will not damage the switches in ZIV DCX. During loading transients the Buck converter may operate at Accelerating Mode and during unloading transients the Buck converter may operate at Braking Mode using the same controller.

Referring to the embodiment of FIG. 9, under Braking Mode operation, the input terminals of the ZIV DCX output inductors (L1, L2, L3, L4) are connected to ground by turning on A23, A24, A27, A28, B23, B24, B27, B28. The other MOSFETs are turned off. Under Braking Mode operation, the voltage across the ZIV inductors is Vo=0.7V. The inductor current decreases quickly. The energy stored in L1, L2, L3, and L4 is transferred to the output capacitor, Cgpu. The output voltage will rise and produce an overshoot.

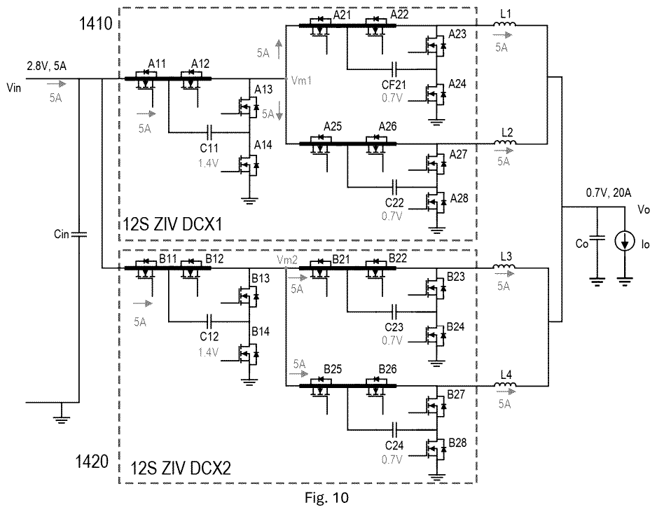

Referring to the embodiment of FIG. 10, under Accelerating Mode operation, the input terminals of the ZIV DCX output inductors (L1, L2, L3, L4) are connected to the input voltage by turning on A11, A12, A21, A22, A25, A26 and B11, B12, B21, B22, B25, B26, as shown in FIG. 10. The voltage across the ZIV inductors is Vin−Vo=2.1V. The inductor current rises quickly. The output voltage will fall initially and then rise and produce an undershoot.

The following subsections describe the operation in more detail under unloading and loading transients.

### Section 3.2.1: Operation During Unloading Transient

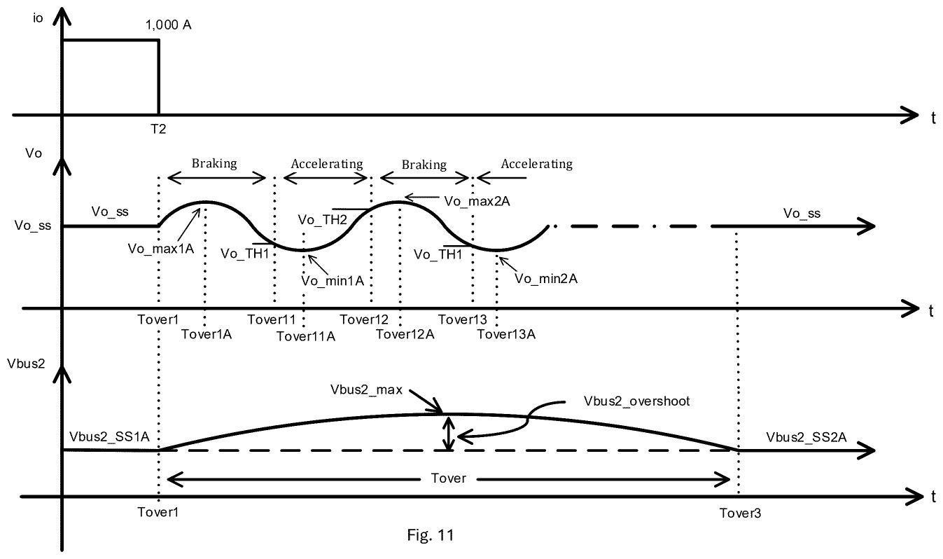

FIG. 11 shows the waveforms of output voltage Vo of the ZIV DCX stage and the output voltage of the Buck stage, Vbus2. At T=T2, the load current steps from high current (1,000 A) to low current (0 A). Shortly after T2, at T=Tover1, the unloading transient is detected e.g., by sensing output voltage or current using a dedicated load transient detection circuit and/or algorithm, which may be implemented in the ZIV DCX Controller (see FIG. 8), and ZIV DCX modules enter Braking Mode operation. Vo rises initially and reaches maximum value Vo_max1A at T=Tover1A. Then, Vo falls and at T=Tover11, Vo falls to Vo_TH1, a threshold voltage selected by design. ZIV DCX modules change to Accelerating Mode operation after Tover11. Because of the time needed to ramp up the inductor current the output voltage Vo continues to fall and reaches Vo_min1A at T=Tover11A. After Tover11A, Vo rises. Since the ZIV inductor value is very small, Vo_min1A is close to Vo_TH1.

At T=Tover12, Vo rises to Vo_TH2, a threshold voltage selected by design. After T=Tover12, the ZIV DCX modules operate at Braking Mode (changed from Accelerating Mode). Due to the energy stored in the inductor, the output voltage Vo rises slightly after Tover12. Vo reaches Vo_max2A at T=Tover12A. Then, Vo begins to fall. When Vo falls to Vo_TH1 at Tover13, the ZIV DCX modules operate in Accelerating Mode again. Vo reaches Vo_min2A at T=Tover13A. This alternating operation of Braking Mode and Accelerating Mode continues until the output voltage of the Buck converter Vbus2 reaches steady state at T=Tover3. After Tover3, the ZIV DCX modules resume normal operation mode and the output voltage Vo is regulated by Vbus2.

Since the time constant of ZIV DCX module is much smaller than the time constant of the Buck converters, the change rate of Vo is much faster than the change rate of Vbus2. Therefore, the ZIV DCX modules experience several Braking and Accelerating modes operation from Tover1 to Tover3.

The energy stored in the ZIV DCX module inductors may be calculated as follows:

$$E\_ind \_ziv = 0.5 * L\_ziv \_eq * Io * Io \qquad ( 9 )$$

Where L_ziv_eq is the equivalent inductor of all the output inductors of ZIV DCX modules connected in parallel during Braking Mode operation. In this example there are 4 inductors in each ZIV DCX module, with each inductor value of 5 nH (L_ziv=5 nH), and there is a total of 50 ZIV DCX modules, therefore:

$$L\_ziv \_eq = L\_zin / ( 4 * 50 ) = 5 nH / 200 = 25 pH ( Pico Henry ) . \qquad ( 10 )$$

Therefore, E_ind_ziv may be calculated as follows:

$$E\_ind \_ziv = 0.5 * 25 pH * 1000 * 1000 = 12.5 uJ ( micro Joules ) . \qquad ( 11 )$$

The required output capacitor Cgpu to limit the maximum output voltage to Vmax=0.8V, or Vo_overshoot=100 mV, may be calculated as follows:

$$Cgpu = E\_ind \_ziv ( Vo * Vo\_overshoot ) = 12.5 / ( 0.7 * 0.1 ) = 179 uF \qquad ( 12 )$$

$$Select Cgpu = 180 uF \qquad ( 12.1 )$$

$$Note : Cgpu\_Buck / Cgpu = 14 , 500 uF / 180 uF = 80. \qquad ( 12.2 )$$

Therefore, in this example a capacitor value of Cgpu=180 uF is needed to keep the GPU overshoot voltage below 100 mV during unloading conditions when GPU current steps from 1,000 A to 0 A and when all the ZIV DCX modules operate at Braking Mode.

Comparing equations (3.1) and (12.1), it can be observed that with the multi-stage power architecture where ZIV DCX modules are connected to GPU and all the ZIV DCX modules operate at Braking Mode, the required GPU capacitor value Cgpu can be reduced from 14,500 uF as in the conventional approach to 180 uF while still limiting the GPU voltage overshoot below 100 mV. This is a capacitor reduction of 80 times.

Of course, in actual implementations, because of the sensing delay and ESR of the ceramic capacitor, the Cgpu used will be larger, such as Cgpu=500 uF (which is a reduction of 30×) or Cgpu=1,000 uF (which is a reduction of 15×). Considering that the printed circuit board (PCB) board area nearby the GPU, CPU, FPGA, etc., is very limited and is at a high premium, this capacitor size reduction is a significant advantage of the embodiments for system design.

In an actual implementation, since the ZIV inductor value is very small, during the transient, the maximum value of Vo_max1A, Vo_max2A, etc., is close to the threshold voltage Vo_TH1. Similarly, the minimum value of Vo_min1A, Vo_min2A, etc., is close to the threshold voltage Vo_TH2. Therefore, the subsequent overshoot (Vo_max2A) is close to Vo_TH2. The subsequent undershoots (Vo_min1A, Vo_min2A) are close to Vo_TH1. Therefore, Vo is controlled tightly by Vo_TH1 and Vo_TH2 during unloading transient. It is not dependent on the output voltage of the Buck converter, Vbus2.

In FIG. 11, it is assumed that the maximum voltage value, Vo_max1A, Vo_max2A, etc., are different. In real cases, they will be very close to each other. Similarly, Vo_min1A, Vo_min2A, etc., will also be very close to each other.

The above analysis demonstrates that a multi-stage power architecture according to embodiments described herein can significantly improve the dynamic performance of a voltage regulator.

It is noted that the value of Vo_max1A is determined by the above calculation. The subsequent max and min value, such as Vo_max2A, Vo_min1A, etc., are controlled by the threshold voltage, Vo_TH1 and Vo_TH2. The subsequent overshoot and undershoot can be controlled to below 100 mV.

Several control strategies can be implemented by the Buck Stage Controller (e.g., FIG. 8) for the Buck converter to regulate Vbus2 during the unloading transition. One control strategy is to set the Buck converter at Braking Mode operation. In this case, Vbus2 will recover to its steady state in the shortest time. Another control strategy is to maintain normal control during the transition. For example, if a PID control is used for the Buck converter during steady state operation, the same PID control is maintained during the unloading transient. The Buck output voltage Vbus2 will experience a transient response and then recover to steady state. The selection of control strategy during the unloading transient is a design selection. With any control method for a Buck converter, the output voltage Vo will still be controlled by Vo_TH1 and Vo_TH2. From an easier practical implementation point of view, it is desirable to maintain the same control method for both steady-state and transient operation of a Buck converter.

If Braking Mode operation is used and the overshoot of Vbus2 is limited to, e.g., 0.4V, the required capacitor value of Cbus2 is calculated at 700 uF when the Buck inductor value is selected as 150 nH. Therefore, in this example Vbus2 will have a total voltage including the overshoot of 3.2V in this case.

### Section 3.2.2: Operation During Loading Transient

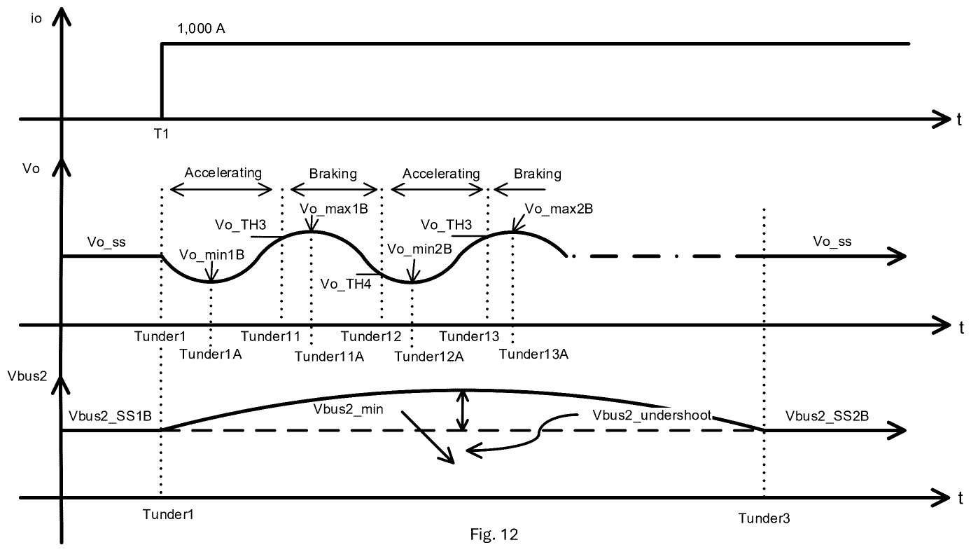

FIG. 12 shows the waveforms of output voltage Vo of the ZIV DCX stage and the output voltage of the Buck stage, Vbus2. At T=T1, the load current steps from low current (0 A) to high current (1,000 A). Shortly after T1, at T=Tunder1, the loading transient is detected and ZIV DCX modules enter Accelerating Mode operation. Vo will fall initially and reach minimum value, Vo_min1B, at T=Tunder1A. Then, Vo will rise. At T=Tunder11, Vo rises to Vo_TH3, a threshold voltage selected by design. The ZIV DCX modules change to Braking Mode operation. Because of the time needed to ramp down the inductor current, the output voltage Vo continues to rise and reach Vo_max1B at T=Tunder11A. After Tunder11A, Vo falls. Since ZIV inductor value is very small, Vo_max1B is close to Vo_TH3.

At T=Tunder12, Vo falls to Vo_TH4, a threshold voltage selected by design. After T=Tunder12, the ZIV DCX modules operate at Accelerating Mode (changed from Braking Mode). Due to the time needed to ramp up inductor current, the output voltage Vo falls slightly after Tunder12. Vo reaches Vo_min2B at T=Tunder12A. Then Vo increases. When Vo increases to Vo_TH3 again at Tunder13, the ZIV DCX modules operate in Braking Mode again. Vo reaches Vo_max2B at T=Tunder13A. This operation continues until the output voltage of the Buck converter Vbus2 reaches its steady state at T=Tunder3. After Tunder3, ZIV DCX modules resume normal operation mode and the output voltage Vo is regulated by Vbus2.

Similarly, since the ZIV inductor value is very small, the subsequent undershoot (Vo_min2B) is very close to Vo_TH4. The subsequent overshoots (Vo_max1B, Vo_max2B) are very close to Vo_TH3. Therefore, Vo is controlled tightly by Vo_TH3 and Vo_TH4 during the loading transient. It is not dependent on the output voltage of the Buck converter, Vbus2.

Similarly, during loading transient, the Buck converter might operate either in Accelerating Mode or under regular PID control mode. When it recovers to steady state operation, the ZIV DCX modules will resume to normal operation mode.

It is noted that due to resistance loss there is a voltage drop across the ZIV DCX modules. If it is assumed the steady state output voltage Vo does not change before and after the load transient, the steady state output voltage value of the Buck converter Vbus2 will be slightly different before and after the load transient to compensate for the voltage drop across the ZIV DCX modules. For example, in FIG. 11, Vbus2_SS1A will be slightly higher than Vbus2_SS2A. Similarly, in FIG. 12, Vbus2_SS2B will be slightly higher than Vbus2_SS1B.

In the above discussion the threshold voltages Vo_TH1, Vo_TH2 are used for the unloading transient and Vo_TH3, Vo_TH4 are used for the loading transient. In practical implementation, the threshold voltage for changing from Accelerating Mode to Braking Mode operation, Vo_TH2, Vo_TH3, may be same. The threshold voltage for changing from Braking Mode to Accelerating Mode operation, Vo_TH1, Vo_TH4, may be same. In the following discussion, same threshold voltage is assumed. Vo_TH_acc is used as the threshold voltage to enter Accelerating Mode (from Braking Mode). Vo_TH_br is used as the threshold voltage to enter Braking Mode (from Accelerating Mode).

The following summarizes the control strategy discussed above:
Step 1: Detection of load transient.
Step 1.1A: If an unloading transient is detected, the ZIV DCX modules will enter Braking Mode operation.
Step 1.1B: When output voltage Vo reaches Vo_TH_acc, ZIV DCX modules enter Accelerating Mode operation. Then go to step 2.
Step 1.2A: If a loading transient is detected, the ZIV DCX modules will enter Accelerating Mode operation.
Step 1.2B: When output voltage Vo reaches Vo_TH_br, ZIV DCX modules enter Braking Mode operation. Then go to step 2.
Step 2: ZIV DCX module will operate repeatedly (i.e., operation will alternate) between Accelerating Mode and Braking Mode to tightly control the output voltage between approximately Vo_TH_acc and Vo_TH_br until Vo recovers.
Step 3: When the output voltage Vbus2 of the Buck converters recovers to its steady state value, the ZIV DCX modules resume normal operating mode with 50% duty cycle and the output voltage is regulated by Vbus2.

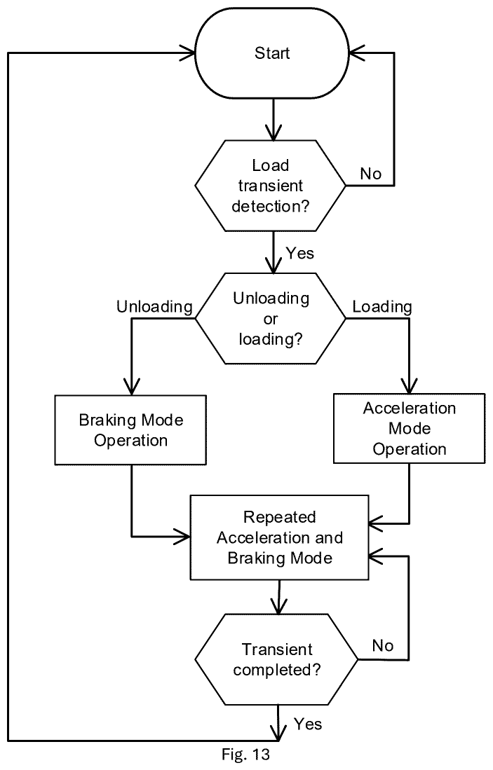

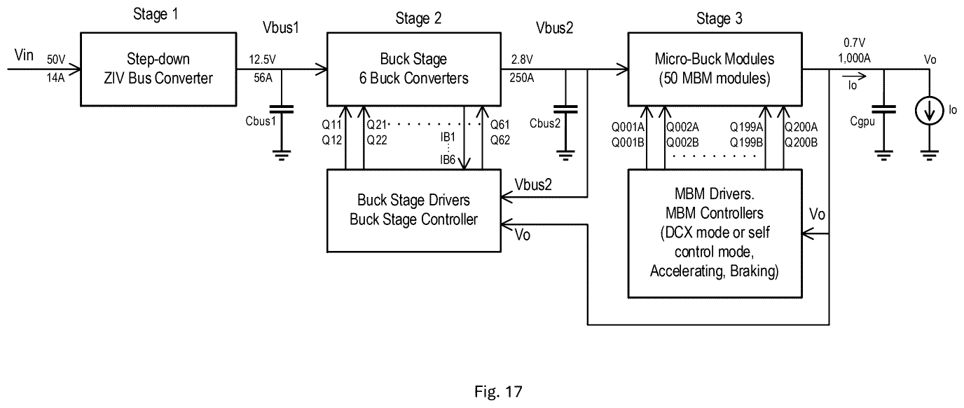

FIG. 13 is a block diagram of control logic for operation alternating between Accelerating Mode and Braking Mode, as described above, according to one embodiment. The embodiments described above and shown in FIG. 13, or variations thereof, may be implemented in the ZIV DCX Controller of FIG. 8 or FIG. 17.

It is noted that as long as Vbus2 variation range is acceptable, other control methods for a Buck converter may be used. The Cbus2 value of 700 uF is not critical.

In the above discussion, a ZIV DCX with voltage gain of 0.25 (4:1 step down) is used. A ZIV DCX with another step down ratio, such as 6:1, 2:1, 3:1, etc., may also be used.

### Section 4: ZIV DCX Modules Implemented With Micro-Buck Modules (MBM)

The equivalent inductor value for ZIV DCX module (stage 3) is much smaller than the equivalent inductor value in Buck converters (stage 2). It is noted that a smaller equivalent inductor value can also be achieved using a plurality of micro-Buck converters connected in parallel. Advantageously, a number (e.g., 4) of micro-Buck converters, related drivers, and control circuits may be implemented together on the same silicon die and operate at higher switching frequency (such as 5 MHz to 10 MHz) than a Buck converter implemented with discrete MOSFETs (e.g., limited to around 1 MHz).

As used herein, the term micro-Buck converter refers to a Buck converter as generally shown in FIG. 15. The term “micro” refers to the feature wherein the Buck converter produces a very small portion of the total output current. For example, in the embodiment described herein a micro-Buck converter produces an output current of 5 A, while the total load current is 1,000 A. In this embodiment a micro-Buck converter produces 0.5% of the total output current. In other embodiments, a micro-Buck converter may produce, e.g., about 0.1% to about 5% of the total output current. Thus, a feature of embodiments is to increase the number of DC-DC converter circuits, wherein each DC-DC converter circuit produces only a small proportion of the total output current, rather than to reduce the number of DC-DC converter circuits as is typical of conventional approaches. The approach described herein advantageously results in better output voltage regulation, faster dynamic response to loading and unloading transients, and greater reliability due to less component stress and significantly smaller output capacitor size. In addition, a micro-Buck converter is in a compact configuration that facilitates implementing multiple micro-Buck converters together in a package, such as together on a single semiconductor die.

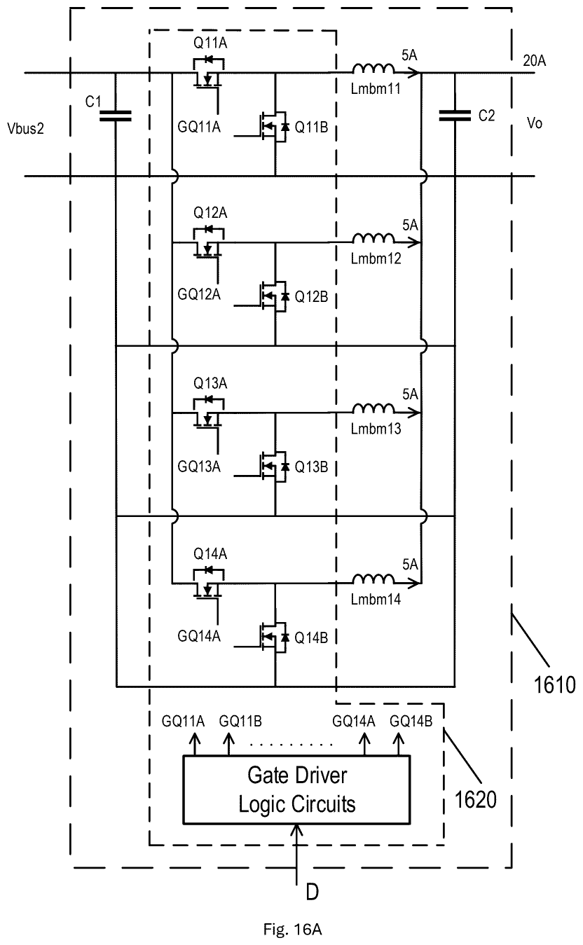

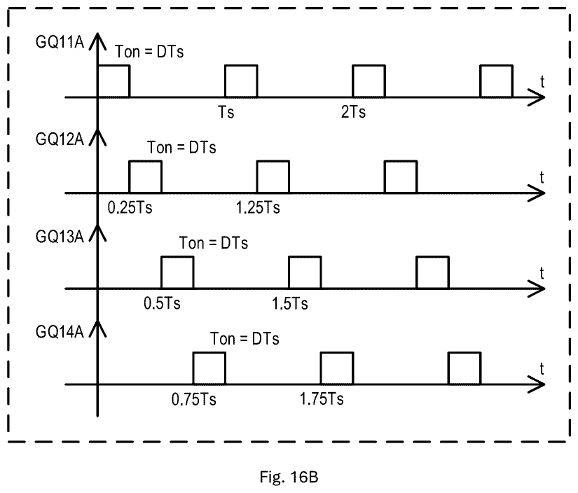

As used herein, the terms “Micro-Buck Module” and “MBM” refer to a module comprising a plurality of micro-Buck converters connected in parallel. For example, an MBM may include four micro-Buck converters, as shown in the embodiment of FIG. 16A. The micro-Buck converter switches (e.g., MOSFETs) together with related drivers and control circuits may be implemented together on the same semiconductor die, e.g., as shown at 1620 in FIG. 16A. The micro-Buck converters in a Micro-Buck Module may operate in an interleaving mode to reduce the input and output current ripple. An MBM package may include the semiconductor die 1620 together with the inductors (Lmbm) of each micro-Buck converter and capacitors C1 and C2, e.g., shown at 1610 in FIG. 16A.

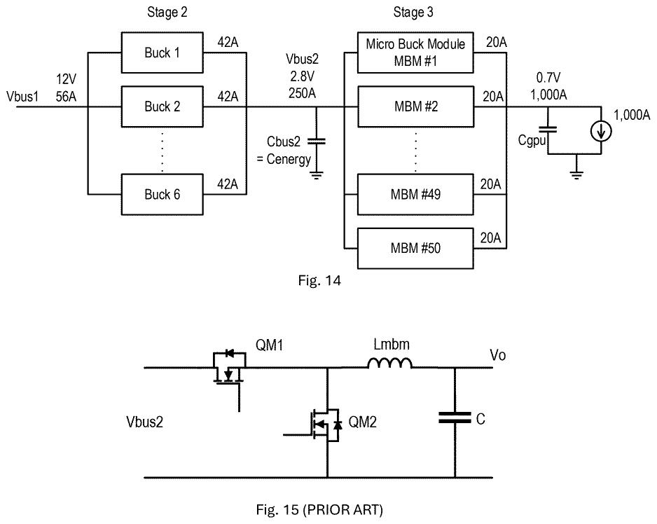

FIG. 14 is a block diagram showing a 2 Stage embodiment with multiple Micro-Buck Modules connected in parallel to serve as a ZIV DCX in Stage 3. It is noted that the inductance value of the Buck converter cannot be arbitrarily small as the Buck inductor voltage depends on its input DC voltage and output DC voltage levels. Nevertheless, the system may be designed so that the energy stored in the micro-Buck inductors is much smaller than the energy stored in the Stage 2 Buck converters. FIG. 15 is a circuit diagram of a Buck converter topology according to the prior art that may be used to implement the micro-Buck converters of the Micro-Buck Modules, according to one embodiment. In FIG. 15 the inductor is indicated by Lmbm in accordance with implementations described herein.

Referring to FIG. 14, in this example it is assumed that each MBM produces 20 A and 50 MBMs are connected in parallel to produce load current of 1,000 A. Since each MBM includes four micro-Buck converters, a total of 200 micro-Buck converters is used. With currently available integrated circuit technology, for 2.8V input and 0.7V output, 5 A output, the duty cycle is around 0.25. A switching frequency of Fs=5 MHz may be used. If the value of Lmbm is selected as 20 nH, the inductor current ripple is estimated at about 5.5 A peak to peak, or the peak MOSFET current is about 7.75 A peak. In this condition, the equivalent inductor value is:

$$L\_mbm \_eq = 20 nH / 200 = 0.1 nH \qquad ( 44 )$$

This is much smaller as compared with the equivalent inductor value of the Stage 2 Buck converters:

$$L\_buck \_eq = 150 nH / 6 = 25 nH \qquad ( 45 )$$

As discussed above, the Buck inductor in Stage 2 is 150 nH.

### Section 4.1: Grouped Micro-Buck Module Structure

In the above example where Vbus2 (the input voltage of the MBM) is around 2.8V and Vo is 0.7V, the duty cycle for the MBM is about 0.25. Therefore, it is beneficial to group four micro-Buck converters into one MBM and operate them in interleaving mode, which reduces the current ripple at the input and output side. Because of the loss in MBM, in order to achieve 25% duty cycle, the output voltage of the Buck converter (Vbus2), or the input voltage of the MBM, may be regulated to a value so that the duty cycle of each micro-Buck converter in one MBM is 25%. This may be a control requirement in some embodiments.

FIGS. 16A and 16B show the circuit diagram and gate drive signals, respectively, for the control MOSFETs for each phase. Block 1610 shows MBM components including capacitors C1 and C2 and four micro-Buck converters in block 1620 connected in parallel. Block 1620 shows the gate driver for the eight power MOSFETs that may be fabricated on the same semiconductor die for the four micro-Buck converters. The gate driver circuits and logic control circuits may also be fabricated on the same semiconductor die. The gate drive signals for the control FETs, Q11A, Q12A, Q13A, Q14A are shown in FIG. 16B. The gate signal for Q11B, Q12B, Q13B and Q14B is complimentary to the gate signal for Q11A, Q12A, Q13A and Q14A. It is noted that the same on time (Ton as shown in the figure) is used for all four Micro-Buck converters for the same switching period. They are also phased shifted by 90 degrees (or 0.25Ts from each other) to achieve interleaving. For example, MOSFET Q11A is turned on at the start of a switching period. Q12A is turned on at 0.25Ts. Q13A is turned on at 0.5TS. Q14A is turned on at 0.75Ts.

When Micro-Buck Modules are used as stage 3, a power system from 50V to 0.7V is shown in the embodiment of FIG. 17.

### Section 4.2: Control Strategy

Since the output voltage of the MBMs can be controlled directly by the duty cycle, the MBMs can operate in two modes, DCX mode and Self-Control mode.

### Section 4.2.1: Micro-Buck Module Operating in DCX Mode

### Steady State Operation:

MBMs operate as a DC transformer (DCX) with a fixed duty cycle value,

e.g., 25% for an input voltage about 2.8V and output voltage about 0.7V. The exact output voltage Vo is controlled by the Buck stage output voltage, Vbus2 as shown in FIG. 14. As Vbus2 is controlled to be 4 times the output voltage so that the duty cycle of each MBM is very close to (or exactly) 25%. When four MBMs are connected in parallel operating at interleaving mode, the input capacitor current ripple is substantially or completely removed. Current sharing among the MBMs may be achieved passively or by a dedicated current share loop. If the current in one module is larger than the others, the conduction loss of that module will increase and temperature will rise. Therefore, the Rds of the MOSFET and the winding resistance of the inductor will increase and the actual current from this module will be reduced.

During loading transient operation, MBMs enter Accelerating Mode when loading transient is detected. When the output voltage rises to above a threshold value, such as Vo_TH3 as shown in FIG. 12, MBMs enter Braking Mode to limit the output voltage to Vo_max1B. MBMs will repeatedly operate between Accelerating Mode and Braking Mode until the output voltage of Buck converter at stage 2, Vbus2, recovers to steady state. After that, MBMs operate at DCX mode with 25% duty cycle and the output voltage Vo is regulated by Vbus2. The Buck converters in Stage 2 can either be controlled to operate in Accelerating Mode or be controlled by the same feedback loop, such as PID, as the one under steady state. Since the output voltage Vo can be regulated tightly by the repeated Accelerating and Braking Mode operation of MBMs, the control mode for Buck converters (in stage 2) is not critical for limiting the output voltage undershoot and overshoot.

During unloading transient operation, MBMs enter Braking mode when unloading transient is detected. When the output voltage falls to below a threshold value, such as Vo_TH1 as shown in FIG. 11, MBMs enter Accelerating Mode to limit the output voltage to Vo_min1A. MBMs will repeatedly operate between Braking Mode and Accelerating Mode until the output voltage of Buck converter at stage 2, Vbus2, recovers to steady state. After that, MBMs operate at DCX mode with 25% duty cycle and the output voltage Vo is regulated by Vbus2. The Buck converters in Stage 2 can either be controlled to operate in Braking Mode or be controlled by the same feedback loop, such as PID, as the one under steady state. Since the output voltage Vo can be regulated tightly by the repeated Braking and Accelerating Mode operation of MBMs, the control mode for Buck converters (in stage 2) is not critical for limiting the output voltage undershoot and overshoot.

### Section 4.2.2: Self-Control Mode Operation

With Self-Control mode, the output voltage Vo of the MBM is controlled by its duty cycle. In this case, Vbus2 is regulated at approximately 2.8V (i.e., about 4× the output voltage) so that the duty cycle of the Micro-Buck Module is very close to 25% so that when four micro-Buck converters are connected in parallel with interleaving operation, the input current is almost DC, and the output voltage ripple is substantially or completely removed.

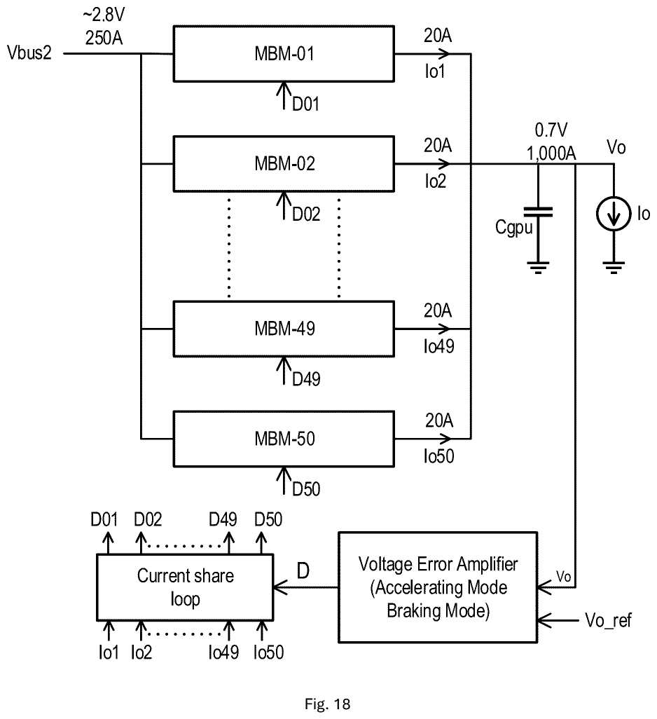

FIG. 18 shows a block diagram of an embodiment implemented with 50 self-controlled MBMs. Each MBM may be a 4-phase interleaved micro-Buck converter, e.g., as shown in FIG. 16A, block 1610. The four micro-Buck converters of each MBM are controlled with the same duty cycle, with interleaving operation.

Referring to FIG. 18, during steady state operation, the output voltage Vo is sensed, and the Voltage Error Amplifier produces a master duty cycle D. The Current Share Loop senses the output current information of each MBM, Io1, Io2, . . . , Io49, Io50, and generates 50 duty cycles, D01, D02, . . . , D49, D50, to control the 50 MBM modules. In the examples used in this specification, each micro-Buck converter produces 5 A output current and each MBM module produces 20 A output current. For 1,000 A output current, 50 MBM modules are needed according to this example.

One key feature of the Self-Control mode is that one voltage loop is used, and it produces a master duty cycle, D. The Voltage Error Amplifier may be located inside a master controller chip. The current share loop may be located inside the control circuit of each MBM module or located inside the master controller chip.

During loading transient conditions (in this example, the GPU current steps from 0 A to 1,000 A), the MBM modules enter Accelerating Mode operation so that the output voltage may be recovered quickly. As discussed previously, the control FETs of all the micro-Buck converters are turned on, and the input voltage is directly applied to the left side of the inductor (Lmbm). The inductor current rising rate may be calculated as:

$$I\_Ind \_rising = ( Vin - Vo ) / L\_mbm \_eq = ( 2.8 - 0.7 ) / ( 20 nH / 200 ) = 21 A / ns \qquad ( 50 )$$

When the output voltage Vo, which is the same as the GPU voltage Vgpu, recovers to its steady state level, the MBM modules will resume steady state operation when the output voltage is controlled by the Voltage Error Amplifier and Current Share Loop, as shown in FIG. 18.

With 21 A/ns rise time and maximum loading current of 1,000 A the inductor current rise time is:

$$T\_ind \_rise = 1 , 000 A / ( 21 A ns ) = 48 ns ∼ = 50 ns ( from 0 A to 1 , 000 A ) \qquad ( 51 )$$

In this example the switching frequency of the micro-Buck converters is 5 MHz (switching period of 200 ns). Therefore, the Accelerating Mode operation takes less than one switching period.

In some embodiments the Accelerating Mode operation may also be implemented as duty cycle that is much larger than the steady state duty cycle of 0.25. For example, a duty cycle of D_acc=50% to 95% may be used for Accelerating Mode operation.

During unloading transient conditions (e.g., GPU current steps from 1,000 A to 0 A), all the MBM modules enter Braking mode operation to limit the output voltage overshoot. As discussed previously, the SR FETs of all the micro-Buck converters are turned on, and the output voltage is applied to the inductor (Lmbm). The inductor current falling rate can be calculated as:

$$I\_ind \_falling = Vo / L\_mbm \_eq = 0.7 V / ( 20 nH / 200 ) = 21 A / ns \qquad ( 52 )$$

When the output voltage Vo, which is the same as the GPU voltage Vgpu, recovers to its steady state level, the MBM modules resume to steady state operation when the output voltage is controlled by the Voltage Error Amplifier and Current Share Loop, as shown in FIG. 18.

With 7 A/ns rise time and maximum loading current of 1,000 A, the inductor current rise time is:

$$T\_ind \_fall = 1 , 000 A / ( 7 A / ns ) = 143 ns \text{∼=} 150 ns ( from 1 , 0000 A to 0 A ) \qquad ( 52 )$$

For the example where the switching frequency of the micro-Buck converters is 5 MHz (or switching period of 200 ns), the Braking Mode operation takes less than one switching period.

In some embodiments the Braking Mode operation may be implemented as duty cycle that is much smaller than the steady state duty cycle of 25%. For example, a duty cycle of D_braking=2 to 10% may be used for Braking Mode operation.

As discussed above, Accelerating Mode operation and Braking Mode operation will last only for around one switching period. Therefore, it would be acceptable that neither Accelerating Mode nor Braking Mode operation is used during the load transient. Here, during load transient conditions, the Voltage Error Amplifier and Current Share loop may be used to regulate the output voltage. However, it is understood that it will take a longer time for the output voltage to recover to its steady state value.

To summarize, with self-controlled Micro-Buck Modules as shown in FIG. 18, one control strategy is to use a Voltage Error Amplifier and Current Share Loop for both steady state and transient operation. Another control strategy is to use Accelerating Mode and Braking Mode operation for loading and unloading transient condition and Voltage Error Amplifier and Current Sharing Loop for steady state operation.

While the above power structure and control strategy can achieve very fast loading and unloading response time, two potential issues may need to be addressed. The first issue is that it is difficult to achieve accurate current sharing among a large number (e.g., 200) of micro-Buck converters. Very accurate current sensing is required, which is difficult to achieve for low voltage and high current applications.

The second issue is that the Micro-Buck Modules may be located in different places on a PCB board (motherboard). The PCB track length, and therefore the track resistance between the output terminals of each MBM module and the load points are different for different MBM modules. Therefore, if the output voltage of MBM modules is the same, they may deliver different current. For example, if MBM-01 is located very close to the load point and MBM-50 is located far away from the load point, MBM-01 will deliver higher current than MBM-50. The current difference must be compensated by the Current Share Loop. Usually the response time of the Current Share Loop is much slower than the response time of the voltage loop. Current Mode Control may be used to address these two potential issues.

### Section 5: Current Mode Control

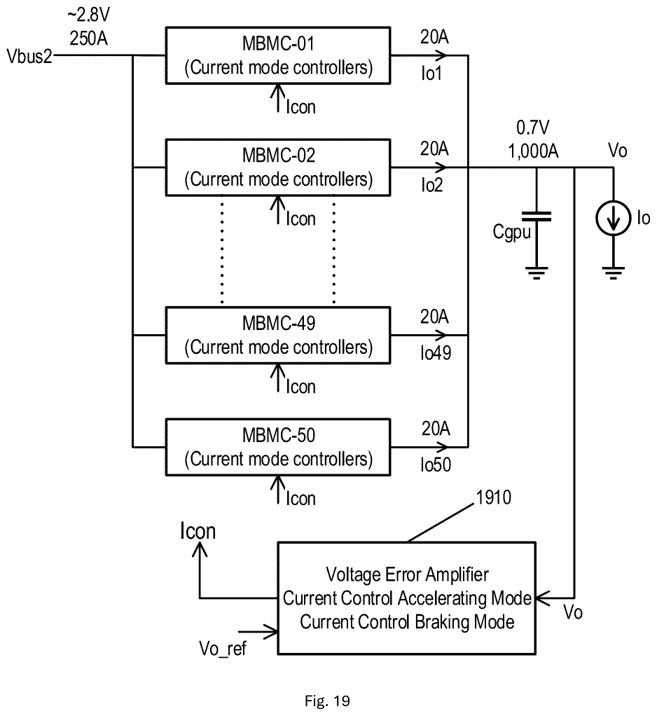

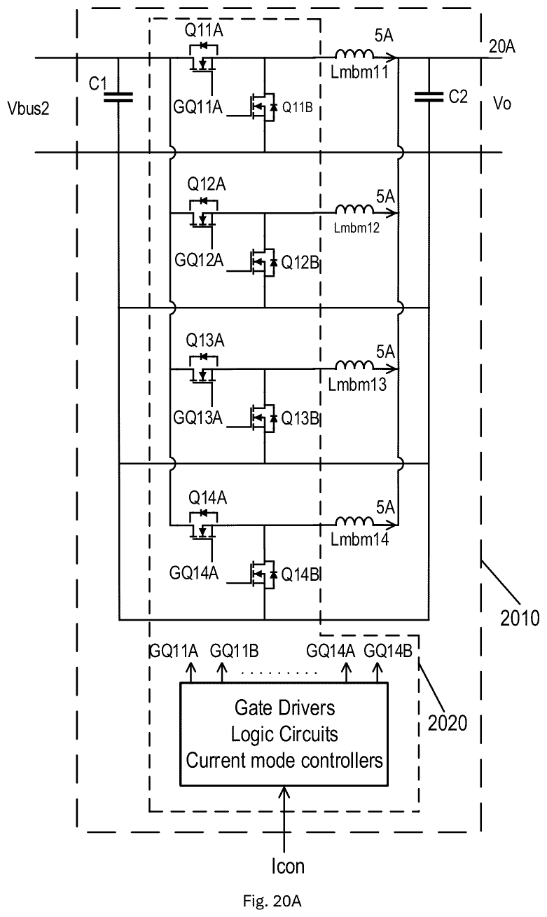

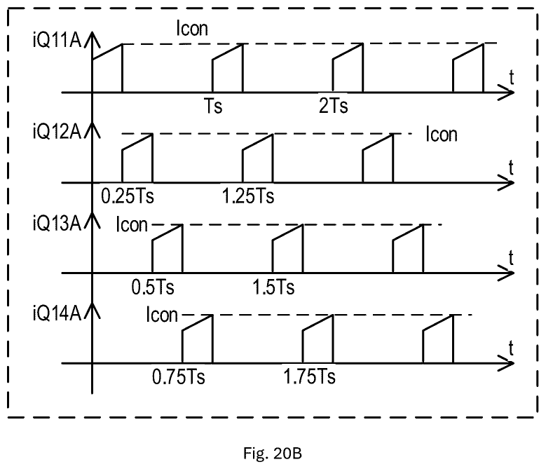

FIG. 19 is a block diagram of self-controlled Micro-Buck Modules using Current Mode Control, according to one embodiment. A Current Mode Controller is included with each Micro-Buck Module, referred to as MBMC. In one embodiment each MBMC includes four micro-Buck converters, a current mode controller, drivers, and related logic circuits. In some implementations it may be desirable to use one current mode controller circuit for each micro-Buck converter. Therefore, in some embodiments, four current mode control circuits may be used for four micro-Buck converters. FIG. 20A shows a circuit diagram of the current mode controllers for four micro-Buck converters (MBMC). In FIG. 20A block 2010 shows MBMC components including capacitors C1 and C2 and four micro-Buck converters connected in parallel. Block 2020 shows the logic circuits, current mode controller, and gate driver for the eight power switches (e.g., MOSFETs) that may be fabricated on the same semiconductor die as the eight MOSFETs for four micro-Buck converters. The gate drive signals for the control switches, Q11A, Q12A, Q13A, Q14A are shown in FIG. 20B. The gate drive signals for the SR switches, Q11B, Q12B, q13B and Q14B are complimentary to the control switches. Referring to FIG. 20B, when the current through control FET Q11A reaches Icon, it is turned off. Similarly, when the currents through control FETs, Q12A, Q13A, Q14A reach Icon they are turned off. Q12A is turned on 0.25Ts after Q11A is turned on. Q13A is turned on 0.25Ts after Q12A is turned on and Q14A is turned on 0.25Ts after Q13A is turned on. It is noted that the four micro-Buck converters are controlled with the same current command, Icon, with interleaving operation. In some embodiments four current mode controller circuits are used for the four micro-Buck converters, wherein each current mode controller circuit controls one micro-Buck converter.

As noted above, the circuit in block 2020 may be implemented in the same silicon die. Input capacitor C1, output capacitor C2, and inductor Lmbm may be implemented externally to the silicon die in the same MBMC package. The duty cycle of each micro-Buck converter is about 25%, (achieved by adjusting and/or selecting the Vbus2 value), and four micro-Buck converters operate at interleaving mode, the current ripple through input capacitor C1 is very low or substantially zero. With a duty cycle at or very close to 25% the current ripple will be at or very close to zero. C1 may be implemented by a silicon capacitor. A small value of C2 may be used.

As shown in FIG. 19, the output voltage Vo is sensed and compared with a reference voltage (Vo_ref). The output of the voltage error amplifier Icon is the current control signal for all 50 MBMC modules. In FIG. 20B, peak current mode control is assumed. Q11A turns on at the starting of the switching period. Q11A is turned off when its current reaches Icon. Similarly, Q12A turns on at T=0.25Ts. It turns off when its current reaches Icon. Q13A turns on at T=0.5Ts and turns off when its current reaches Icon. Q14A turns on at T=0.75Ts and turns off when its current reaches Icon.

In the above example, the steady state duty cycle is 0.25. No sub-harmonic oscillation will occur even without compensation slope for peak current mode control. For applications when sub-harmonic oscillation is possible, compensation slope should be added. The details are known to those of ordinary skill in the art and are not discussed here.

With existing silicon fabrication process, the current through control FETs (Q11A, Q12A, Q13A, Q14A) may be sensed with sensing FET technology as is known in the art. The details are not discussed here.

With current mode control as shown in FIG. 19, the output current of each current mode controlled Micro-Buck Module (MBMC) becomes a current source and is tightly controlled. Current sharing is automatically achieved. In addition, from dynamic point of view, it will not introduce any problem when a large number of current sources are connected in parallel. In the above example, 200 current sources are connected in parallel.

The above description relates to steady state operation.

During a load transient, Accelerating Mode and Braking Mode operation may be used to reduce the output voltage overshoot and undershoot. The details are discussed below.

Again, it is noted that an important feature is that the inductor current slew rate is much faster than the inductor current slew rate of the Buck converter in stage 2 (e.g., in FIG. 17).

### Section 5.1: Current Control Accelerating and Braking Mode Operation

Described herein are Current Mode Accelerating Mode operation and Current Mode Braking Mode operation. When a loading transient is detected, the system enters Current Control Accelerating Mode (CCAM) operation. When an unloading transient is detected, the system enters Current Control Braking Mode (CCBM). It is expected they can achieve very good dynamic performance with easier implementation than approaches described above in section 3 and section 4.

### Section 5.2: Current Control Accelerating Mode (CCAM) Operation

With conventional accelerating mode operation, the duty cycle is increased to 100% or a value much larger than the steady state duty cycle, such as 50% to 95% when the steady state duty cycle is 25%. When a large number of micro-Buck converters are connected in parallel (such as 200 micro-Buck converters) and the equivalent inductor value is very small (such as 100 pH), it is difficult to limit the excessive overshoot and undershoot during the transient and the switch-over from accelerating (or braking) mode back to normal mode operation. This is not desired.

According to Current Control Accelerating Mode (CCAM) operation, when a loading transient is detected, instead of setting the duty cycle to a large value, such as 100%, 90%, etc., a large current reference, Icon_acc, is set for CCAM operation. Since the inductor current follows the reference current tightly, the average inductor current rises quickly and reaches a value controlled to Icon_acc. The value of Icon_acc is a design parameter. It is desired to set Icon_acc to be higher than the peak inductor current at full load. For example, with the example described in this specification, the maximum peak inductor current at full load is I_ind_max_pk=7.75 A (5 A DC inductor current value plus 2.75 A inductor current ripple). The Icon_acc may be set at 10% to 100% above peak inductor current, such as Icon_acc=10 A (30% above I_ind_max_pk).

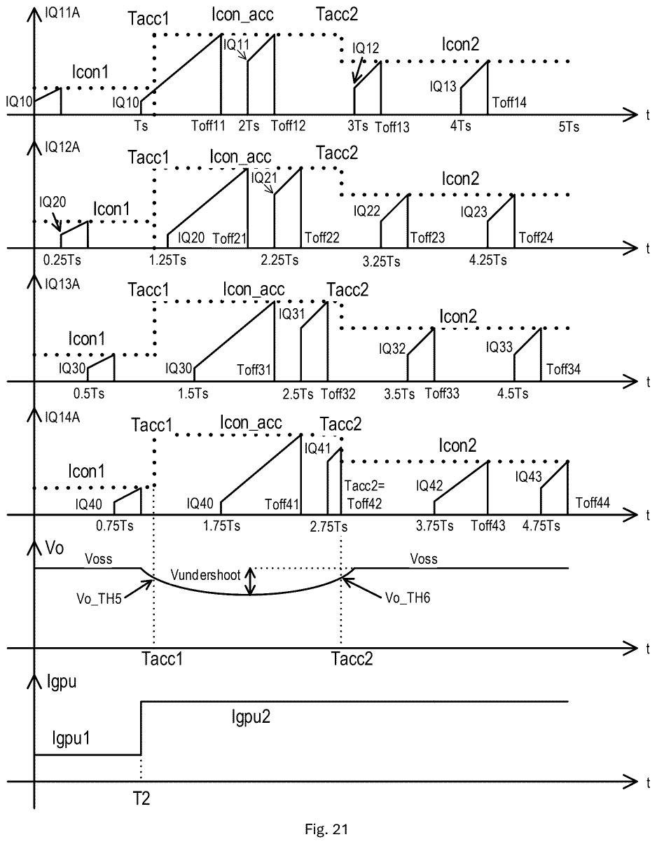

The CCAM operation is described in detail with reference to the exemplary waveforms shown in FIG. 21 using one MBMC module as an example. In the figure, IQ11A, IQ12A, IQ13A, IQ14A represent the current through four control FETs, Q11A, Q12A, A13A, and Q14A.

It is assumed that the load (e.g., GPU) experiences a loading transition (from Igpu1 to Igpu2>Igpu1) at T=T2. The output voltage Vo will fall. When Vo drops to below Vo_TH5 at T=Tacc1, Current Control Accelerating Mode operation is enabled at Tacc1. The current control signal Icon is set to Icon_acc. Icon_acc is a large current, such as Icon_acc=10 A, which is higher than the maximum peak inductor current, I_ind_max_pk. After Tacc1, Vo will fall initially and then Vo will rise. When the output voltage Vo rises to above another threshold, Vo_TH6, at T=Tacc2, Current Control Accelerating Mode is disabled, and the control current loop takes over and the control current Icon=Icon2.

Detailed operation is explained with reference to FIG. 21. It is assumed that initially, the system operates at steady state, and the current control reference is Icon1. In steady state operation, the current through Q11A starts at IQ10 when it is turned on. At T=Tacc1, CCAM is enabled, and the current control reference value jumps to Icon_acc. It is assumed that Tacc1 happens after Ts. At T=Tacc1, Q11A is already turned on. At T=Toff11, IQ11A reaches Icon_acc. Q11A turns off at Toff11. In an actual implementation, a max duty cycle limitation circuit may be added to limit the maximum duty cycle of each control FET to below 100%. The limit may be, e.g., 50% to 90%. The limit may be selected based on design parameters. It is assumed in this specification that the control FET current will reach Icon_acc before maximum duty cycle limit. At T=2Ts, Q11A turns on again. Since the duty cycle in the previous switching period is larger, the inductor current is increased. The starting current for Q11A at T=2Ts is IQ11. It will take less time for Q11A to reach Icon_acc. At T=Toff12, IQ11A reaches Icon_acc and Q11A is turned off.

At T=1.25Ts, Q12A turns on. It starts at current value of IQ20, which is the steady state value. At T=Toff21, IQ12A reaches Icon_acc. Q12A turns off at Toff21. At T=2.25Ts, Q12A turns on again. Since the duty cycle in the previous switching period is larger, the inductor current is increased. The starting current for Q12A at T=2.25Ts is IQ21. It will take less time for Q12A to reach Icon_acc. At T=Toff22, IQ12A reaches Icon_acc and Q12A is turned off.

Similarly, at T=1.5Ts, Q13A turns on. It starts at current value of IQ30, which is the steady state value. It T=Toff31, IQ13A reaches Icon_acc. Q13A turns off at Toff31. At T=2.5Ts, Q13A turns on again. Since the duty cycle in the previous switching period is larger, the inductor current is increased. The starting current for Q13A at T=2.5Ts is IQ31. It will take less time for Q13A to reach Icon_acc. At T=Toff32, IQ13A reaches Icon_acc and Q13A is turned off.

At T=1.75Ts, Q14A turns on. It starts at current value of IQ40, which is the steady state value. At T=Toff41, IQ14A reaches Icon_acc. Q14A turns off at Toff41. At T=2.75Ts, Q14A turns on again. Since the duty cycle in the previous switching period is larger, the inductor current is increased. The starting current for Q14A at T=2.75Ts is IQ41. It will take less time for Q14A to reach Icon_acc. At T=Toff42, IQ14A reaches Icon_acc and Q14A is turned off.

In the above discussion, the inductor current reaches the Icon_acc in one switching cycle. This is a reasonable assumption because with the micro-Buck design, the inductor value is small and the inductor current rises quickly. In a practical design with the Micro-Buck Module power architecture, it will take one or two switching cycles for the inductor to reach the reference current Icon_acc for Current Control Accelerating Mode (CCAM) operation.

As shown in FIG. 21, at T=Tacc2, output voltage Vo rises above Vo_TH6 and the Current Control Accelerating Mode operation is disabled. In this example, Tacc2 is just before 3Ts. At T=Tacc2, the current reference becomes Icon2.

At T=Tacc2, Q11A is already off. At T=3Ts, Q11A turns on with its initial current value of IQ12. Q11A will operate at current mode control with reference current of Icon2. Q11A turns off at T=Toff13 when its current reaches Icon2. Q11A will turn on at T=4Ts and turn off at T=Toff14 when its current reaches Icon2.

At T=Tacc2, Q12A is already off. At T=3.25Ts, Q12A turns on with its initial current value of IQ22. Q12A will operate at current mode control with reference current of Icon2. Q12A turns off at T=Toff23 when its current reaches Icon2. Q12A will turn on at T=4.25Ts and turn off at T=Toff24 when its current reaches Icon2.

At T=Tacc2, Q13A is already off. At T=3.5Ts, Q13A turns on with its initial current value of IQ32. Q13A will operate at current mode control with reference current of Icon2. Q13A turns off at T=Toff33 when its current reaches Icon2. Q13A will turn on at T=4.5Ts and turn off at T=Toff34 when its current reaches Icon2.

At T=Tacc2, Q14A turns off immediately as its current value is above Icon2. That is, Tacc2=Toff42. At T=3.75Ts, Q14A turns on with its initial current value of IQ42. Q14A will operate at current mode control with reference current of Icon2. Q14A turns off at T=Toff43 when its current reaches Icon2. Q14A will turn on at T=4.75Ts and turn off at T=Toff44 when its current reaches Icon2.

During the transition, one or two large duty cycles are produced during the transient and recovery from the transient. Since the Current Control Accelerating Mode operation lasts only one or two switching periods based on the design, no sub-harmonic oscillation will occur.

### Simulation

A computer simulation using PSIM™ (Altair Engineering Inc.) was performed to illustrate the operation of Current Control Accelerating Mode and Current Control Braking Mode operation for one MBMC module (consisting of four Micro-Buck converters operating at 25% and interleaving). In the simulation, the parameters were switching frequency=5 MHz, micro-Buck inductor, L(mbm), =20 nH, C2=20 uF. Input voltage was about 2.8V and output voltage was 0.7V.

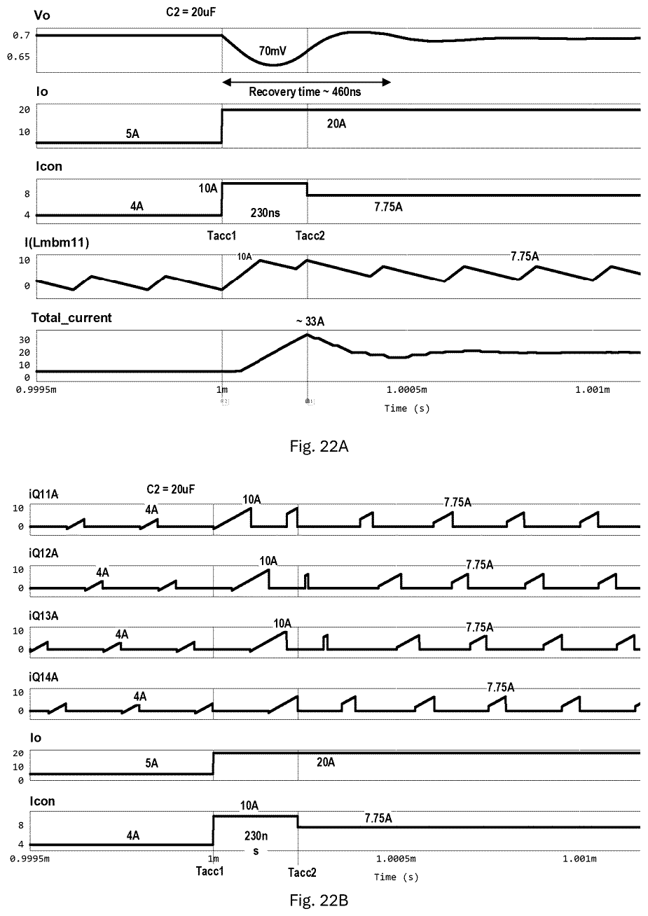

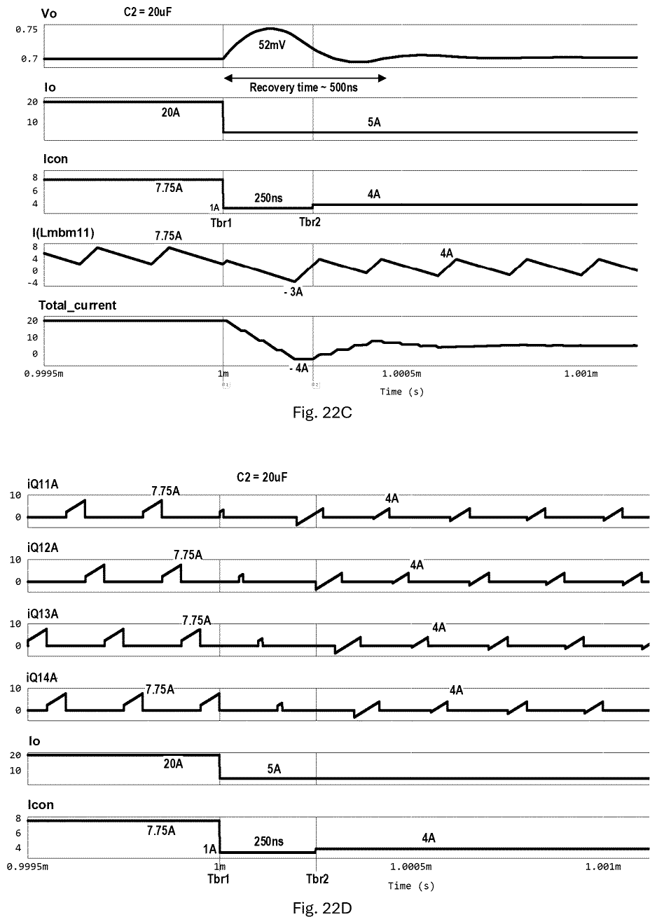

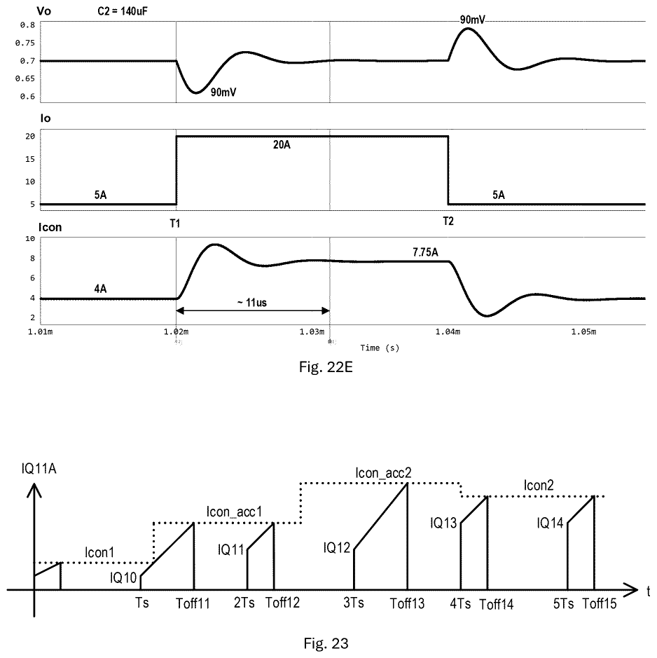

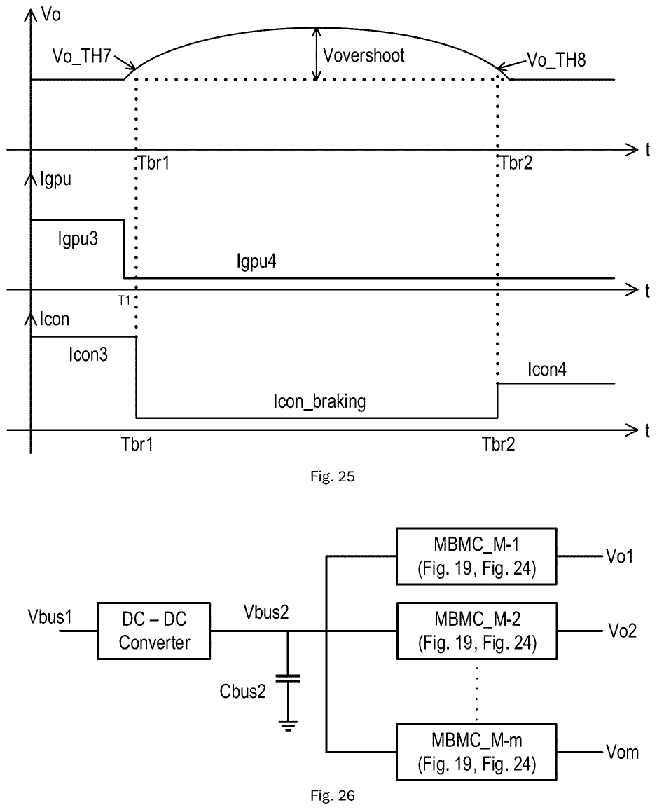

Key waveforms during a loading transient are shown in FIGS. 22A and 22B. As shown in FIG. 22A, before the output current step at T=Tacc1, the output current of MBMC module (total current of four micro-Buck converters) is Io=5 A. Each micro-Buck converter produces 1.25 A. As the inductor current ripple is about 5.5 A peak to peak, the Icon value is around 4 A. At T=Tacc1, the load current steps from 5 A to 20 A. The output voltage drops, as shown in FIG. 22A. Immediately after Tacc1, the Icon value is set to Icon_acc=10 A (entering Current Control Accelerating Mode). The inductor current of first micro-Buck converter, I(Lmbm11), rises and Q11A turns off when I(Lmbm11) reaches 10 A. The total inductor current (four inductor currents added together) will reach a peak value of around 33 A (as shown in the bottom waveform). At T=Tacc2, Current Control Accelerating Mode operation ends, and Icon is set to 7.75 A, which is the output of the Voltage Error Amplifier. The output voltage recovers to 0.7V. The voltage undershoot is around 70 mV. In this example the time interval between Tacc1 and Tacc2 is around 230 ns and the recovery time is estimated at around 460 ns. FIG. 22B shows the control FETs current for each micro-Buck converter. In general, the time interval when the system operates at Current Mode Accelerating Mode is determined by the time required for the output voltage to reach the sensed output voltage thresholds, which are selected by design. For example, for a loading transient, the thresholds may be Vo_TH5 and Vo_TH6 (FIG. 21) and for an unloading transient the thresholds may be Vo_TH7 and Vo_TH8 (FIG. 25).

Key waveforms during an unloading transient are shown in FIGS. 22C and 22D. As shown in FIG. 22C, before the output current step (Tbr1), the output current of MBMC module (total current of four micro-Buck converters) is Io=20 A. Each micro-Buck converter produces 5 A. As the inductor current ripple is about 5.5 A peak to peak, the Icon value is around 7.75 A. At T=Tbr1, the load current steps from 20 A to 5 A. The output voltage rises, as shown in FIG. 22C. Immediately after Tbr1, the Icon value is set to Icon_braking=1 A (Current Control Braking Mode). The inductor current of first micro-Buck converter, I(Lmbm11), falls to a negative value, around −3 A. This is achieved as the SR FET remains on when control FET is turned off. The total inductor current (four inductor currents added together) will fall to a negative value of around −4 A before Tbr2.

A negative inductor current value means that the extra energy stored in the output capacitor, Cgpu, is transferred to its input side and is recovered. It is noted that the extra energy in the output capacitor is initially transferred from the energy stored in the inductor after the unloading transient. This is significantly different from the conventional braking mode operation when the SR switch is not turned on. If the SR switch is not turned on, the energy stored in the inductor is partially dissipated at the body diode of the SR switch and partially transferred to the output capacitor, which translates into the extra energy stored in the output capacitor and causes voltage overshoot. That is, in the conventional approach this extra energy cannot be transferred to the input as the SR switch is not turned on.

At T=Tbr2, Current Control Braking Mode operation ends, and Icon is set to around 4 A, which is the output of the Voltage Error Amplifier. The output voltage recovers to 0.7V. The voltage overshoot is around 52 mV. The time interval between Tbr1 and Tbr2 is around 250 ns. The recovery time is estimated at around 500 ns. FIG. 22D shows the current of the control FETs for each micro-Buck converter.

FIG. 22E shows the response of the output voltage, Vo, with a conventional PID controller for the voltage error amplifier. At T=T1, the load current steps from 5 A to 20 A and at T=T2, the load current steps from 20 A to 5 A. In this case, the output capacitor C2 has to be increased to 140 uF (7 times the value of 20 uF used for CCAM and CCBM operation in the embodiment described above) to limit the output voltage undershoot and overshoot to be around 90 mV. The recovery time is around 11 us.

The above simulation demonstrates that significant performance improvement can be achieved by the Current Control Accelerating Mode and Current Control Braking Mode operation according to embodiments described herein.

The actual GPU current (not shown) is the sum of 50 MBMC modules and is 50 times the value as shown in FIGS. 22A and 22C.

### Observations

Based on the foregoing, the following can be observed:
Observation 1: The output current does not increase indefinitely. It is controlled (limited) by Icon_acc. For example, although the peak current for each micro-Buck converter is 10 A, which corresponds to average inductor current of around 7.75 A (considering inductor current ripple of 5.5 A peak to peak), the peak value of the total output current would be around 33 A.
Observation 2: Each MOSFET conducts less than 100% duty cycle.
Observation 3: Since the output current does not rise as fast as the conventional Accelerating mode operation when all the control FETs are turned on at same time, the Vo recovery time of the Current Control Accelerating Mode will be longer than the conventional Accelerating Mode operation. However, since the inductor value of the micro-Buck converter is very small, the overall output current ramp up is still fast enough so that the output voltage undershoot, Vo_undershoot, is 70 mV as shown in the simulation, which is less than 100 mV as assumed in this embodiment, even at a very small output capacitor value of 20 uF.
Observation 4: The switch over from Current Control Accelerating Mode operation or Current Control Braking Mode operation to normal operation will be smooth since the equivalent circuit is a current source charging output capacitor. This is a significant advantage of the approach described herein.
Observation 5: It is assumed that no inter-module interleaving is used. In other words, MBMC-01, MBMC-02, up to MBMC-50 operate at same phase. Inter module interleaving between all or some of the MBMC modules may be used. Specific implementation details are not discussed for the sake of brevity.
Observation 6: the Peak Inductor Current Is Tightly Controlled by Icon_acc and the inductor will not saturate.
Observation 7: As SR FETs remain on when control FETs are off, the actual inductor current could become negative, which will allow for additional energy transfer from the output capacitor to the input voltage of the micro-Buck Module. This illustrates to some degree that the overshoot, Vo_overshoot=52 mV, is actually smaller than undershoot, Vo_undershoot=70 mV, according to the described embodiment. This is an advantageous feature of the control technology described herein.
Observation 8: When 50 MBM4 modules are connected in parallel, the output capacitor is also increased to Cgpu1=20 uF*50=1,000 uF. As an example, in this condition, when the GPU current has a loading condition from 5*50=250 A to 20*50=1,000 A, the GPU voltage undershoot will be still 70 mV. Similarly, when GPU current has an unloading condition from 1,000 A to 250 A, the overshoot will be 52 mV. Thus, the architecture achieves very good performance minimizing output voltage undershoot and overshoot.
Observation 9: Based on the exemplary conditions herein, if a conventional PID controller is used, the required GPU capacitor is Cgpu2=140 uF*50=7,000 uF to limit the overshoot and undershoot to around 90 mV. Thus, it is noted that using a conventional PID control strategy the Cgpu2 is 7 times the Cgpu1=1,000 uF needed with CCAM and CCBM control strategy as described herein. Nevertheless, Cgpu2 of 7,000 uF is still much smaller (roughly half) than the capacitor value of 14,500 uF required by the conventional method.

To limit the maximum duty cycle value, two current accelerating levels can be used, as shown in FIG. 23. At T=Tacc1A, the current accelerating level jumps to Icon_acc1. All the control FETs are turned off at Icon_acc1, and the inductor current will be controlled to a value close to Icon_acc1. At T=Tacc1B, the current accelerating level jumps to Icon_acc2. The control FETs are turned off at Icon_acc2, and the inductor current is controlled to a value close to Icon_acc2. At T=Tacc2, the system exits from Current Control Accelerating Mode (CCAM) operation and resumes to normal current mode control with current reference Icon2. The currents through the control FETs, Q12A, Q13Q, Q14Q, are similar. Their operation is not repeated.

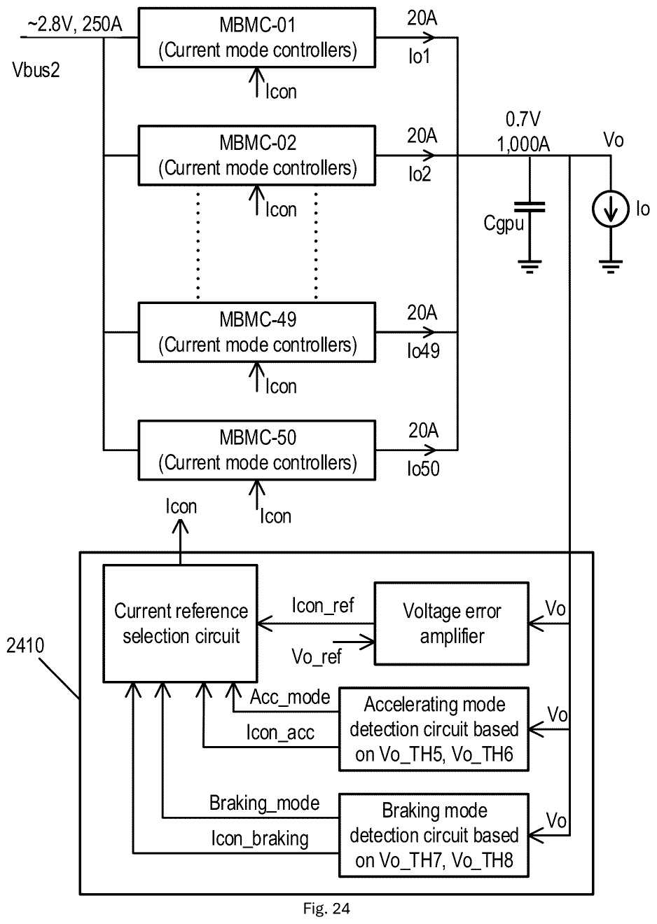

FIG. 24 is a control circuit block diagram for Current Control Accelerating Mode and Current Control Braking Mode operation, according to one embodiment. The output voltage Vo is sent to the Accelerating Mode detection circuit. The Accelerating Mode detection circuit generates two signals. One is a logic signal, Acc_mode, to indicate that Current Control Accelerating Mode operation is enabled. The other is the current accelerating level, Icon_acc. When CCAM operation is enabled, the output of the current reference selection circuit, Icon, will be equal to Icon_acc.

$$Icon = Icon\_acc , Current Control Accelerating Mode enabled \qquad ( 53 )$$

It is noted that during normal operation, neither Current Control Accelerating Mode nor Current Control Braking Mode operation is enabled and the output of the current reference selection circuit is Icon_ref, which is the output of the voltage error amplifier.

$$Icon = Icon\_ref , at normal operation . \qquad ( 54 )$$

When Current Control Accelerating Mode is disabled after Tacc2, the Current reference Selection Circuit will select the output of the Voltage Error Amplifier, Icon_ref, as its output:

$$Icon = Icon\_ref = Icon 2 , after CCAM operation disabled \qquad ( 55 )$$

The above analysis shows that a smooth transition from Current Control Accelerating Mode operation to normal current mode control can be achieved. The interleaving operation is maintained during both Current Control Accelerating Mode operation and normal operation.

### Section 5.3: Current Control Braking Mode (CCBM) Operation

After the detailed discussion of Current Control Accelerating Mode operation in the above section, the Current Control Braking Mode (CCBM) operation may be readily understood. The GPU current (Igpu), output voltage (Vo), and current control signal (Icon) waveforms during Current Control Braking Mode operation are shown in FIG. 25.

It is assumed that the GPU current has a step down change from Igpu3 to Igpu4 (Igpu4<Igpu3) at T=T1. When Vo rises above Vo_TH7 at T=Tbr1, Current Control Braking Mode operation is enabled at Tbr1. The current control signal Icon is set to Icon_braking. Icon_braking is a very small value and may be zero. The output voltage Vo will rise first and then fall. When the output voltage Vo falls to below another threshold, Vo_TH8 at T=Tbr2, Current Control Braking Mode is disabled, and the control current signal is Icon4 (as shown in FIG. 25), which is determined based on the output of the Voltage Error Amplifier Icon_ref, as shown in FIG. 24.

That is, when Current Control Braking Mode operation is enabled, the output of the Control Reference Selection Circuit is Icon_braking.

$$Icon = Icon\_braking , Current Control Braking Mode enabled \qquad ( 56 )$$

When Current Control Braking Mode is disabled after T=Tbr2, the Current Reference Selection Circuit will select the output of the Voltage Error Amplifier, Icon_ref, as its output:

$$Icon = Icon\_ref = Icon 4 , after CCBM operation disabled \qquad ( 57 )$$

It is noted that in Current Control Braking Mode operation, the micro-Buck converter (e.g., shown in FIG. 15) operates at synchronization rectifier mode. The SR FET (QM2) is still turned on when control FET (QM1) is off. Under this operation mode, the energy stored in the GPU capacitor (Cgpu) is transferred to the input of the micro-Buck converter. In the above example (5 A max DC current, 5.5 A peak to peak inductor current ripple), if the Icon_braking=2.75 A, the average inductor current (I_ind_avg) will be zero (0). If Icon_braking=1 A, I_ind_avg=−1.75 A. Therefore, the energy stored in inductors of the micro-Buck inductor can be recovered during the transient. In contrast, with conventional braking mode operation the SR FET is not turned on and the inductor energy is dissipated in the body diode of the SR FETs.

### Section 5.4: Current Control Only Operation

As described herein, Icon_acc, Icon_acc1, Icon_acc2, and Icon_braking, are design parameters and may be selected based on the system requirements. With Current Control Accelerating Mode and Current Control Braking Mode operations, the output voltage overshoot and undershoot can be minimized.

With a large number of micro-Buck converters in parallel (4*50=200 in the example used in this specification), the equivalent inductance value is very small (100 pH in the above example), the conventional current mode control (without Current Control Accelerating Mode and/or Current Control Braking Mode operation) could also be used to provide acceptable dynamic performance during loading and unloading transient conditions. The overshoot and undershoot may still be limited to being less than 100 mV (or some other value when large enough GPU capacitors (Cgpu) are used. In certain conditions it is possible that the output voltage undershoot and overshoot requirements can be satisfied with a Voltage Error Amplifier only, without the Current Control Accelerating Mode, or Current Mode Braking Mode operation. It is understood that in such a case, a much larger Cgpu value will be needed. However, the equivalent inductance value of embodiments based on Current Control Accelerating Mode and Current Mode Braking Mode operation as described herein is much smaller than that of the conventional approaches, e.g., shown in FIG. 1.

One possible control strategy is that Current Control Accelerating Mode and Current Control braking Mode operation is activated only when the GPU current has a large enough step change. For example, CCAM and CCBM may be activated only when the GPU current step is larger than 25%, or 30%, or 40%, 50%, or other selected percentage of the full load current.

In other embodiments the Current Control Accelerating Mode operation is set to a pre-determined time interval during a loading transient and the Current Control Braking Mode operation is set to a pre-determined time interval during an unloading transient. This strategy is possible because Current Mode control allows smooth transition from Accelerating Mode and/or Braking Mode operation to normal operation. This can simplify the implementation circuits.

### Section 5.5: Summary With Micro-Buck Module Architecture

Based on the above discussion, the following is a summary of the GPU power architecture using micro-Buck Modules (MBM).

Features of MBM: a micro-Buck Module consists of N micro-Buck converters connected in parallel. The micro-Buck converters operate in interleaving mode to reduce the input and output current ripple. Each micro-Buck converter produces a small portion of the output current. The example used in this specification is 200 micro-Buck converters are used to produce the load current. Each micro-Buck converter produces 5 A (0.5% of total load current) and the total load current is 1,000 A. Of course, other configurations, such as each micro-Buck converter produces 0.1% to 5% of the load current, are possible. As noted above, embodiments are based in part on a strategy that uses a large number of Buck converters (micro-Buck converter) to produce the required load current (GPU current), while each micro-Buck converter produces a very small portion of the total load current (e.g., such as 0.1% to 5%). This is significantly different from existing approaches based on a strategy to produce as much current as possible for each Buck converter, such as each Buck converter produces 50 A current and total of 20 Buck converters are needed for 1,000 A total output current, or each Buck converter produces 100 A output current and 10 Buck converters are needed for 1,000 A total output current. In contrast, according to embodiments described herein, accurate current sharing is achieved by (1) current mode control with the same current control signal Icon for all micro-Buck converters, and (2) using a voltage stepdown ratio of about 4 (or other values higher than 2) so that no slope compensation is needed for current mode control and the average inductor current can be controlled very tightly.

In some embodiments it may be desirable to select the N as the same value as the input to output voltage ratio. For example, for 2.8V input and 0.7V output, Vin/Vo=2.8/0.7=4, so N=4 is selected. N may also be selected as multiple of the input to output voltage ratio, such as N=8 or 12. In this case, the current ripple of the input capacitor (C1 in FIG. 16) is substantially or completely cancelled (zero) by interleaving operation. The current ripple of the output capacitor (C2 in FIG. 16) is also zero. In this case, the output voltage of the Stage 2 Buck converters (which is same as the input voltage of the Micro-Buck Modules) is regulated so that the duty cycles of the Micro-Buck Modules are at or very close to 25% to achieve optimal ripple cancellation. This means that at heavy load, Vbus2 will be higher than 4*Vo to compensate for the losses in the Micro-Buck Modules.

If, e.g., input voltage to output voltage ratio is 3, N is selected as 3, 6, 9, or other values multiple of 3 to achieve substantially complete current ripple cancellation. Since the input voltage of the MBM can be selected, this can be achieved in actual implementations. Further, if input voltage to output voltage ratio is 3.5, 7 micro-Buck converters may be used to achieve substantially complete current ripple cancellation.

If the voltage step down ratio N of the MBM is selected at 4 the Buck converter at stage 2 (as shown in FIG. 17) will produce 250 A, which is 25% of the GPU current. Since the Buck converter is limited by the output current, the total number of Buck converters can be reduced by 4 times. In the example used in this specification, 6 Buck converters are used with the exemplary architecture, while with the conventional solution as shown in FIGS. 1, 20 Buck converters are needed. Since the Buck converters use the same components, the cost reduction from 20 Buck converters to 6 Buck converters is significant.

If voltage mode control is used, one duty cycle is used to control all the micro-Buck converters in one MBM. A current share circuit may be needed to ensure each MBM will produce same output current.

If current mode control is used, the peak inductor current Icon is used as a control signal for all the MBMC modules (as shown in FIGS. 19 and 24) and the average inductor current in each micro-Buck converter will be equal. In this case, current sharing is automatically achieved.

The MBM may operate in DCX mode or self-control mode. With DCX mode, the duty cycle is fixed at steady state operation. It operates at Accelerating Mode or Braking Mode during loading and unloading transients to limit the overshoot and undershoot of the output voltage.

It may be desirable that the MBM operates in self-control mode and with current mode control. With current mode control, at steady state, a current reference, Icon, is sent to all the MBMC. Icon is the output of the Voltage Error Amplifier. During loading and unloading transients, Current Control Accelerating Mode or Current Control Braking Mode operation is enabled. With Current Control Accelerating Mode operation, a high reference current Icon_acc is sent to all the MBMC modules so that the inductor current can be ramped up quickly. Current Control Accelerating Mode will end when the output voltage Vo recovers. With Current Control Braking Mode, a very small reference current Icon_braking is sent to all the MBMC modules so that the inductor current can be reduced quickly. Current Control Braking Mode will end when the output voltage Vo recovers. It may be required that the output voltage of the stage 2 Buck converter, Vbus2, which is the input voltage of the Micro-Buck Modules, is regulated so that the duty cycle of the Micro-Buck Modules is very close to 25%, such as from 24.5% to 25.5% for best ripple cancellation.

### Section 5.6: Practical Implementations

In the above discussion, analog implementation is used to illustrate certain embodiments of the control strategy: (1) the current control signal is generated by one voltage amplifier (e.g., as shown at block 1910 in FIG. 19 and block 2410 in FIG. 24), and it used to control a plurality of micro-Buck converters, and (2) peak current mode control is implemented in each micro-Buck Module. However, in a practical implementation, considering high switching frequency (such as 5 MHz or higher), low output voltage (such as 0.7V), high load current (such as 1,000 A), a possibly long wiring or printed circuit board (PCB) track length between the controller (Voltage Error Amplifier) and the MBMC, a complex analog circuit design is required to ensure noise free transmission. In certain embodiments digital control may be implemented with present IC technology to address these challenges.

Predictive Peak Current Mode Control [3] is a digital peak current mode control technology that senses the inductor current through the SR FET when it is conducting at the time instant close to the end of the present switching period and then estimates (i.e., calculates) the on time of the control FET for the next switching period so that the control FET is turned off when the inductor current reaches the desired control current, Icon. This method achieves the same objective as the peak current control discussed above, such as illustrated in FIG. 20B, FIG. 21, etc.

For example, assume that the inductor current at the end of the present switching period is sensed as I_valley and the control current is Icon for the next switching period. With inductor value L, input voltage Vin, and output voltage Vo, the required on-time Ton of the control FET for the next switching period may be calculated as

$$Ton = L \times ( Icon - I\_valley ) / ( Vin - Vo ) \qquad ( 60 )$$

which may be calculated by the digital circuit very quickly.

In other embodiments Parallel Current Mode Control [4] may be used. According to this approach the inductor current is measured at the end of the switching period (when SR FET is conducting) and is used together with the reference current to determine the duty cycle of the next switching period to control the inductor current.

Other method embodiments, digital valley current mode control may also be used to achieve the same objective as described above. The details are not discussed in this specification.

It will be appreciated that each micro-Buck converter will need a current mode controller. Therefore, four current mode controllers are needed in the embodiments described herein, e.g., as shown in FIG. 19, FIG. 24, etc. With digital current mode control (such as Predictive Peak Current Mode Control, parallel current mode control), the inductor current for each of the four micro-Buck converters is sensed. Since the sampling instants for the four inductor currents are evenly spaced within one switching period Ts because of interleaving operation, one analog to digital converter may be sufficient for one MBMC module to sample all the inductor currents in practical implementations.

In some practical implementations, the Icon signal may be routed from the master control chip (e.g., block 1910 as shown in FIG. 19, block 2410 in FIG. 24) to each of the MBMC modules. Noise may be introduced into Icon from the PCB tracks between the master controller (FIG. 19 block 1910, FIG. 24 block 2410) and MBMC modules. Therefore, it may be advantageous to transmit Icon information using digital signal protocols. Considering that the switching frequency is high, such as 5 MHz or higher, and there are a large number of receivers (e.g., 50 MBMC modules in the above embodiments), a digital signal transmission protocol, such as M-LVDS (Multipoint Low-Voltage Differential Signaling) may be used.

Other digital implementation issues, such as sampling of inductor current through SenseFTE, sampling of input voltage and output voltage, interleaving operation, may be resolved during the design stage as will be evident to those or ordinary skill in the art.

Although embodiments are described herein primarily based on micro-Buck converters for low voltage, high current (e.g., 2.8V to 0.7V, 1,000 A) applications, it will be appreciated that other types of DC-DC converters, such as three-level Buck converters and 12-switch ZIV topologies may also be used. Further, embodiments and approaches described herein may be readily adapted to other applications requiring different voltage conversions and output current requirements.

It is noted that in FIG. 19 and FIG. 24, blocks 1920, 2410 (central control unit) are drawn separately from the current mode controllers of each MBMC block. While they may be implemented on separate chips, in some embodiments the complete control function may be implemented on one controller chip. In a practical implementation, some of the signals may be integrated together. For example, in one implementation the Icon_acc and Icon_braking values may be stored in the MBMBC modules and block 2410 (central control unit) transmits logic signals Acc_mode (for Current Control Accelerating Mode operation) and Braking_mode (for Current Control Braking Mode operation) to each of the MBMC blocks. Such an implementation reduces the time delay and improves reliability of the signal transmission from the current reference selection circuit to all the MBMC modules.

### Section 5.7: Extension to Multiple Output Voltage Rails

The embodiments and examples discussed above were based on one output voltage rail. The same architecture may also be used for multiple output voltage rails. This is important because for a typical GPU power application or other power applications, several independently controlled voltage rails are needed, such as a voltage rail for GPU core 1, a voltage rail for GPU core 2, a voltage rail for HBM (High Bandwidth Memory) blocks, a voltage rail for RAM (Random Access Memory), a voltage rail for a network port, a voltage rail for SSD (Solid State Disk) drive, etc. Applying an architecture as described herein achieves better performance for these requirements.

FIG. 26 is a block diagram of a multiple output voltage rail structure, according to one embodiment. The DC-DC converter at stage 2 converts Vbus1 to Vbus2. It may be implemented with several Buck converters, as shown in FIG. 17, or other topologies. MBMC_M-1 produces Vo1. MBMC_M-2 produces Vo2, and MBMC_M-m will produce Vom. Vo1, Vo2, . . . , Vom, may be the same or different. For example, Vo1 may be used to power GPU core 1, Vo2 may be used to power GPU core 2, Vom may be used to power a HBM memory block, etc.

Each MBMC_M block may include one or more current mode controlled MBMC modules to achieve a desired output current, together with current mode controllers, central control unit, as well as other required circuits. Current Control Accelerating Mode and Current Control Braking Mode operations may be used, and an architecture based on FIG. 19 or FIG. 24 may be used. E.g., based on the numerical example described above, if the load current of voltage rail 1, Vo1, is 500 A and Vo1 is 0.7V, 25 MBMC modules may be connected in parallel to generate 500 A and one central control unit may used to regulate Vo1 to the designed value.

Since the output voltages may be different for each voltage rail, a design approach is to select Vbus2 to be a multiple (e.g., 4×) of the output voltage with the maximum load current. This achieves very good input current ripple and output current ripple cancellation effects. The design details are not presented here as they would be apparent to one of ordinary skill in the art based on the approaches and embodiments described herein.

All cited documents are incorporated herein by reference in their entirety.

### EQUIVALENTS

Those of ordinary skill in the art will recognize, or be able to ascertain through routine experimentation, equivalents to the embodiments described herein. Such equivalents are within the scope of the invention and are covered by the appended claims.

### REFERENCES

[1] T. Liu and Y. F. Liu, “Two-Phase Three-Level Converter and Controller Therefor”, U.S. Pat. No. 10,498,236 B2, Dec. 3, 2019
[2] S. D. Webb and Y. F. Liu, “Zero Inductor Voltage Converter Topology with Improved Switch Utilization”, U.S. Pat. No. 11,043,899 B2, Jun. 22, 2021
[3] J. Chen, A. Prodic', R. W. Erickson, and D. Maksimovic, “Predictive Digital Current Programmed Control”, IEEE TRANSACTIONS ON POWER ELECTRONICS, VOL. 18, NO. 1, JANUARY 2003, pp. 411-419
[4] W. Zhang, Y. F. Liu, B. Wu, “Parallel Current Mode Control Using a Direct Duty Cycle Algorithm with Low Computational Requirements to Perform Power Factor Correction”, U.S. Pat. No. 7,317,625 B2, Jan. 8, 2008

1. A DC-DC converter, comprising:
a plurality of DC-DC converter circuits connected together in parallel and adapted to receive a DC input voltage and output a DC output voltage; and
a controller that implements current mode control of the plurality of DC-DC converter circuits;
wherein the controller senses the DC output voltage and generates a current reference signal based on the sensed DC output voltage;
wherein the current reference signal is transmitted to the plurality of DC-DC converter circuits;
wherein an output current of each of the plurality of DC-DC converter circuits is based on the current reference signal;
wherein the plurality of DC-DC converter circuits together produce a total load current.

2. The DC-DC converter of claim 1, wherein the controller comprises a voltage error amplifier that is used to generate the current reference signal.

3. The DC-DC converter of claim 1, wherein the controller implements current control accelerating mode in response to a loading transient.

4. The DC-DC converter of claim 1, wherein the controller implements current control braking mode in response to an unloading transient.

5. The DC-DC converter of claim 3, wherein the controller terminates current control accelerating mode when the output voltage recovers to a selected value.

6. The DC-DC converter of claim 4, wherein the controller terminates current control braking mode when the output voltage recovers to a selected value.

7. The DC-DC converter of claim 3, wherein the controller terminates current control accelerating mode after a pre-determined time interval.

8. The DC-DC converter of claim 4, wherein the controller terminates current control braking mode after a pre-determined time interval.

9. The DC-DC converter of claim 1, comprising a plurality of DC-DC converter circuits connected together in parallel as a DC-DC converter module;
wherein the controller implements interleaved operation of the plurality of DC-DC converter circuits to substantially reduce or eliminate at least one of input current and output current ripple.

10. The DC-DC converter of claim 1, wherein the DC input voltage is selected to be a value that substantially reduces or eliminates input current ripple by interleaving operation of the plurality of DC-DC converter circuits.

11. The DC-DC converter of claim 1, wherein each of the plurality of DC-DC converter circuits produces about 0.1% to about 5% of the total load current.

12. The DC-DC converter of claim 4, wherein each of the plurality of DC-DC converter circuits comprises a Buck converter including a synchronous rectifier (SR) switch, a control switch, and an inductor;
wherein the controller controls operation of each Buck converter during current control braking mode operation wherein the SR switch is turned on when the control switch is turned off;
wherein inductor energy is transferred to an inductor input side to reduce an output voltage overshoot.

13. The DC-DC converter of claim 1, wherein the controller implements predictive peak current mode control for each DC-DC converter circuit.

14. The DC-DC converter of claim 13, wherein the controller implements a digital signal transfer protocol to transfer the current reference signal of the controller to a current reference input of each of the DC-DC converter circuits.

15. The DC-DC converter of claim 1, wherein the plurality of DC-DC converter circuits comprises four Buck converter circuits connected together in parallel as a module;
wherein the controller operates the four Buck converter circuits according to an interleaved duty cycle of about 25%.

16. The DC-DC converter of claim 9, where in the DC-DC converter comprises at least first and second DC-DC converter modules;
wherein respective output voltages of the at least first and second DC-DC converter modules are different.

17. A controller for a DC-DC converter comprising a plurality of DC-DC converter circuits connected together in parallel and adapted to receive a DC input voltage and output a DC output voltage, wherein the controller controls operation of the plurality of DC-DC converter circuits to regulate the output voltage, comprising:
using a sensed output voltage to generate a current reference signal and to generate at least one of a current control accelerating mode signal and a current control braking mode control signal;
wherein applying the current control accelerating mode signal controls operation of the plurality of DC-DC converter circuits in response to a loading transient;
wherein the controller terminates the current control accelerating mode signal when the output voltage recovers to a selected value;
wherein applying the current control braking mode signal controls operation of the plurality of DC-DC converter circuits in response an unloading transient;
wherein the controller terminates the current control braking mode signal when the output voltage recovers to a selected value.

18. A method for implementing a DC-DC converter, comprising:
providing a plurality of DC-DC converter circuits connected together in parallel and adapted to receive a DC input voltage and output a DC output voltage; and
using a controller that implements current mode control of the plurality of DC-DC converter circuits;
wherein the controller senses the DC output voltage and generates a current reference signal based on the sensed DC output voltage;
wherein the current reference signal is transmitted to the plurality of DC-DC converter circuits;
wherein an output current of each of the plurality of DC-DC converter circuits is based on the current reference signal;
wherein the plurality of DC-DC converter circuits together produce a total load current.

19. A method for controlling for a DC-DC converter comprising a plurality of DC-DC converter circuits connected together in parallel and adapted to receive a DC input voltage and output a DC output voltage, wherein the controller controls operation of the plurality of DC-DC converter circuits to regulate the output voltage, comprising:
using a sensed output voltage to generate a current reference signal and to generate at least one of a current control accelerating mode signal and a current control braking mode control signal;
wherein applying the current control accelerating mode signal controls operation of the plurality of DC-DC converter circuits in response to a loading transient;
wherein the controller terminates the current control accelerating mode signal when the output voltage recovers to a selected value;
wherein applying the current control braking mode signal controls operation of the plurality of DC-DC converter circuits in response an unloading transient;
wherein the controller terminates the current control braking mode signal when the output voltage recovers to a selected value.
